(19) United States
(12) Patent Application Publication
(10) Pub. No.: US 2009/0327141 A1
(43) Pub. Date: Dec. 31, 2009

(54) HIGHLY EFFICIENT SECRECY-PRESERVING PROOFS OF CORRECTNESS OF COMPUTATION

(76) Inventors: Michael O. Rabin, Cambridge, MA (US); Rocco A. Servedio, New York, NY (US); Christopher Thorpe, Lincoln, MA (US)

Correspondence Address: LANDO & ANASTASI, LLP, ONE MAIN STREET, SUITE 1100, CAMBRIDGE, MA, 02142, US

(21) Appl. No.: 12/105,508

(22) Filed: Apr. 18, 2008

Related U.S. Application Data
(60) Provisional application No. 60/925,042, filed on Apr. 18, 2007.

(51) Int. Cl. G06Q 20/00; H04L 9/28; G06F 7/58

(52) U.S. Cl. 705/75; 380/28; 708/250; 705/37

(57) ABSTRACT

Presented are methods and systems for highly efficient proofs of correctness of computations that preserve secrecy of the input values and calculations. One embodiment includes a method for verifiably determining at least one output for a secrecy preserving computations where the method includes acts of calculating an output from submitted inputs according to an announced calculation, translating a value in the calculation into two components that are a randomized representation of that value, publishing commitments to the at least two components, revealing a portion of the randomized representation in response to a verification request, and enabling verification of the calculation of the output using the revealed portion of the randomized representation. According to one aspect of the secrecy preserving verification the numbers involved in the secrecy preserving calculation are represented by a randomly constructed representing pair. In another aspect, revealing one member of the pair allows for verification without compromising secrecy. In one embodiment, arrangement of the translation process ensures that in the verification only truly independently random numbers, or operations on them, are revealed and checked.

### RELATED APPLICATIONS

This application claims priority under 35 U.S.C. §119(e) to U.S. Provisional Application Ser. No. 60/925,042, entitled “HIGHLY EFFICIENT SECRECY-PRESERVING PROOFS OF CORRECTNESS OF COMPUTATION,” filed on Apr. 18, 2007, which is herein incorporated by reference in its entirety.

### FEDERALLY SPONSORED RESEARCH

This invention was made with Government support under grants CCR-0205423, CCF-0347282, and CCF-0523664 awarded by the National Science Foundation. The Government has certain rights in the invention.

### BACKGROUND

Zero Knowledge Proofs come in a number of flavors. One is direct ZKPs for membership in a NP language, for example proofs that a graph is 3-colorable. These proofs are usually phrased in terms of the particular problem they address, for example talking about graphs and their representations. Another approach deals with circuits and the bit-inputs resulting in certain outputs. This approach is of course very comprehensive since other problem representations are directly translatable into problems about circuits.

There is an extensive literature dealing with ZKPs via encryptions, especially homomorphic encryptions. Verification of processes such as electronic elections or auctions is done via encrypting the relevant numbers such as vote counts or bids, and performing operations such as additions or comparisons on these numbers in their encrypted form. In the work by Parkes, Rabin, Shieber and Thorpe, titled “Practical secrecy-preserving, verifiably correction and trustworthy auctions,” for example (and the literature quoted there), a protocol is proposed for conducting secure and secrecy preserving auctions. Bidders submit bids to an Auctioneer in an encrypted and committed manner. The Auctioneer posts the encrypted bids on a bulletin board. He then opens the bids and computes, according to the posted auction rules, who the winner(s) is (are) and their payments. The Auctioneer then posts a publicly verifiable Zero Knowledge proof for the correctness of the results. This can be done in a manner revealing the identities of the winners and their payments or, if so desired, concealing that information. But in any case, the bids of all other bidders except for those of the winners remain secret. The only trust assumption made is that the Auctioneer, who knows the bid values, will not reveal that information. The protocol described employs Paillier's homomorphic encryption and proofs of order relations between bids, and correctness of other operations on bids are presented by and verified on encrypted values.

It was shown in “Practical secrecy-preserving, verifiably correction and trustworthy auctions” that the protocols given there are practical and that currently available computing power suffices to implement auctions with thousands of bidders within reasonably practical time. Still, that solution employs special encryption functions and the basic Paillier encryption is a relatively heavy computation.

Also, when it comes to verification via encrypted values, in previous approaches there is the need to employ special encryptions such as Paillier's encryption, requiring special intractability assumptions (“Practical secrecy-preserving, verifiably correction and trustworthy auctions,” for example). The operations on encrypted values involve computations with numbers with thousands of bits and are quite slow.

### SUMMARY

Presented is a highly efficient method for proving correctness of computations while preserving secrecy of the input values. In one embodiment, this is done in an Evaluator-Prover model which can also be realized by a secure processor. Another embodiment includes an application to secure auctions.

One embodiment is implemented as an Evaluator-Prover (EP) model, the EP receives input values x₁, . . . ,xₙ which are elements of a finite field Fₚ where p is a 128-bit prime. One should appreciate that other sized prime numbers may be used. In one example, the Evaluator-Prover computes a function value y=ƒ(x₁, . . . ,xₙ) by a publicly announced and agreed upon straight line computation (program) SLC. The EP then publishes the value y and supplies a proof of the correctness of the computation. In one embodiment, the proof of correctness can be verified by anybody and this verification method ensures that the probability that an incorrect published result will not be detected is smaller than 2^{-k}, where k is a security parameter. Furthermore, the proof does not reveal anything about the input values or any intermediate results of the computation, except for what is implied by the published outcome of the computation. According to one aspect, the generality and efficiency of this model allows numerous applications.

One aspect of the secrecy preserving verification is to represent every number xε Fₚ involved in the SLC by a randomly constructed representing pair X=(u₁,u₂) such that x=u₁+u₂. In one embodiment, for the verification of correctness the EP prepares translations of the SLC where for example x,y,x+y (an addition step) is translated into X=(u₁,u₂), Y=(v₁,v₂), W=(w₁,w₂)=X+Y. In another embodiment, the EP posts commitments to all numbers in the translations. In yet another embodiment, a Verifier randomly chooses, for example, the first coordinate, request the EP to reveal (de-commit) u₁, v₁ and w₁, and verify that u₁+v₁=w₁. According to one aspect, a careful arrangement of the translation process ensures that in the verification only truly independently random numbers x, y, u, v, . . .ε Fₚ and their sums or products u+v or u×v are revealed and checked.

Some embodiments allow major efficiency improvements over conventional methods, which prove correctness of computations at the bit and circuit level or employ computations on numbers with thousands of digits. In some commercial applications, such as auctions or purchasing with hundreds of bidders, the efficiency and preservation of secrecy of the method constitute a decisive advantage.

According to another aspect, the advantages of this method are manifold. In some embodiments, working with single or double precision integers and their usual arithmetic operations rather than with bits at the circuit level is considerably more efficient. Conventional translations of high-level operations into circuits raises questions on the correctness of the translation itself. In one embodiment, it is realized that expressing the computation to be verified directly in terms of the numbers and operations involved is more understandable and convincing to general users.

Experimental comparisons obtained between conducting a secure verifiable auction according to some embodiments described herein against a process as discussed in “Practical secrecy-preserving, verifiably correction and trustworthy auctions,” shows a hundredfold efficiency improvement.

In another aspect, it is realized that the applications of ZKP methodology to the conduct of secure secrecy preserving auctions in particular, pose stringent requirements of efficiency on the one hand and of understandability and acceptability by the financial and business communities on the other hand. According to one embodiment, in the context of auctions, disclosed methods have clear advantages over conventional solutions involving homomorphic encryptions, multi-party computations, or reduction to obfuscated circuit computations.

According to one aspect of the present invention, a computer implemented method for verifiably determining at least one output resulting from at least one submitted input according to a predetermined calculation while preserving secrecy of the at least one submitted input and of intermediate values arising in the calculation is provided. The method comprises calculating at least one output resulting from at least one input submitted by at least one participant according to a predetermined calculation, translating a value in the calculation into a randomized representation of that value, wherein the randomized representation comprises at least two components and the at least two components determine the said value through a function, publishing commitments to the at least two components of the randomized representation of that value, revealing a portion of the randomized representation in response to a verification request, and enabling verification of the calculation of the outputs using the revealed portion of the randomized representation. According to one embodiment of the present invention, the method further comprises an act of augmenting the predetermined calculation by insertion of auxiliary values.

According to another embodiment of the invention, the predetermined calculation includes at least one operation of addition, subtraction, multiplication, establishing an inequality between values, and exponentiation. According to another embodiment of the invention, the act of calculating includes an act of performing the at least one operation on the randomized representation of the value to determine the output. According to another embodiment of the invention, the act of enabling verification of the calculation includes using published commitments. According to another embodiment of the invention, the method further comprises an act of submitting, by a participant, an input, and a commitment to the input, and wherein the act of translating the value includes an act of translating, by the participant, the input into a randomized representation of the input, wherein the randomized representation of the input comprises at least two components and the at least two components determine the input through a function.

According to one embodiment of the present invention, the at least two components are a pair of components. According to another embodiment of the invention, the pair of components determine the value through at least one of the functions of addition, subtraction, multiplication. According to another embodiment of the invention, the randomized representation of the value in the calculation comprises a sum of the at least two components of the randomized representation. According to another embodiment of the invention, the sum of values is represented by at least two components each of which is the sum of corresponding components of representations of the values added to yield the sum. According to another embodiment of the invention, the act of revealing a portion of the randomized representation includes revealing one component of the pair of components. According to another embodiment of the invention, the commitments to the at least two components are binding and concealing. According to another embodiment of the invention, the method further comprises an act of digitally signing published commitments with digital signatures. According to one embodiment of the present invention, the method further comprises an act of verifying the digital signatures.

According to another embodiment of the invention, the method further comprises an act of translating a value in the calculation into a plurality of randomized representations of the value. According to another embodiment of the invention, the method further comprises an act of translating a value in the augmented calculation into a plurality of randomized representations of the value. According to another embodiment of the invention, the method further comprises acts of generating a randomized representation of zero, wherein the randomized representation of zero comprises at least two components, wherein the at least two components recover the original value upon application of a function, and wherein the act of translating a value in the calculation into a randomized representation of the original value includes an act of employing the randomized representation of zero in generating randomized representations of calculation values. According to another embodiment of the invention, the method further comprises an act of revealing the at least two components of the randomized representation of zero in response to a request for verification. According to another embodiment of the invention, the method further comprises an act of permitting the verification of the randomized representation of zero.

According to one embodiment of the present invention, the act of calculating the output based on received inputs, includes an act of performing multiple calculations as single operations to reduce the randomized representations required. According to another embodiment of the invention, the act of enabling the verification of the calculation further comprises an act of enabling verification of at least one of a consistent representations of the input, a correct representation of zero, a correct representation of an addition with zero, a correct representation of an addition operation in the predetermined calculation, a correct representation of a multiplication operation in the predetermined calculation, a correct representation of an exponentiation operation in the predetermined calculation. According to another embodiment of the invention, the method is performed by a secure processor connected to an independent secure co-processor that generates random values incorporated into at least one random representation of the value in the predetermined calculation. According to another embodiment, the act of calculating is performed by a calculating entity and the method further comprises an act of publishing a commitment to at least one random value before the at least one input is known to the calculating entity. According to another embodiment, the method further comprises an act of generating the commitments to the at least two components using the at least one random value, and wherein the act of enabling verification of the calculation includes verification of proper use of the at least one random value.

According to one aspect of the present invention, a system for generating a verifiable output according to a predetermined calculation on at least one submitted input that provides for secrecy of the at least one submitted input and of intermediate values in the calculation is provided. The system comprises a calculation component adapted to calculate at least one output from at least one input received from a participant, according to a predetermined calculation, a translation component adapted to translate a value in the predetermined calculation into a randomized representation of the value, wherein the randomized representation comprises at least two components and the at least two components determine the value through a function, and a publication component adapted to publish commitments to the at least two components, wherein the publication component is further adapted to reveal a portion of the randomized representation of the value. According to one embodiment of the present invention, the system further comprises a verification component adapted to verify the calculation of the at least one output using at least one of the revealed portion of the randomized representation of the value and the commitments to the at least two components.

According to another embodiment of the invention, the calculation component is further adapted to perform at least one operation of addition, subtraction, multiplication, establishing an inequality between values, and exponentiation. According to another embodiment of the invention, the calculation component is further adapted to perform the at least one operation on the randomized representation of the value.

According to one embodiment of the present invention, the system further comprises a receiving component adapted to receive an input, and a commitment to the input from a participant. According to another embodiment of the invention, the translation component is further adapted to translate the at least one input into a randomized representation of the input, wherein the randomized representation of the input comprises at least two components and the at least two components determine the input through a function.

According to another embodiment of the invention, the at least two components are a pair of components. According to another embodiment of the invention, the pair of components determine the value through at least one of the functions of addition, subtraction, and multiplication. According to another embodiment of the invention, the randomized representation of the value in the calculation comprises a sum of the at least two components of the randomized representation. According to another embodiment of the invention, the sum of values is represented by at least two components each of which is the sum of corresponding components of representations of the values added to yield the sum. According to another embodiment of the invention, the publication component is further adapted to reveal one component of the pair of components. According to another embodiment of the invention, the commitments to the at least two components are binding and concealing.

According to another embodiment of the present invention, the system further comprises a signature component adapted to sign commitments with digital signatures. According to another embodiment of the invention, the verification component is further adapted to verify a digital signature. According to another embodiment of the invention, the translation component is further adapted to translate a value in the calculation into a plurality of randomized representations of the value.

According to another embodiment of the invention, the translation component is further adapted to generate random representations of zero, and translate the value in the in the predetermined calculation using the random representation of zero, wherein the random representation of zero comprises at least two components, wherein the at least two components determine zero through a function. According to another embodiment of the invention, the publication component is further adapted to reveal the at least two components of the randomized representation of zero. According to another embodiment of the invention, the system further comprises a verification component adapted to verify the randomized representation of zero using the revealed at least two components. According to another embodiment of the invention, the verification component is further adapted to verify at least one of a consistent representations of the input, a correct representation of zero, a correct representation of an addition with zero, a correct representation of an addition operation in the predetermined calculation, a correct representation of a multiplication operation in the predetermined calculation, a correct representation of an exponentiation operation in the predetermined calculation, and a correct representation of establishing an inequality between values.

According to another embodiment of the invention, the system further comprises a secure processor adapted to generate random data, and wherein the translation component is further adapted to employ the random data to translate a value in the in the predetermined calculation into a randomized representation of the value. According to another embodiment of the invention, the secure processor is further adapted to provide a list of digitally signed random values.

According to one aspect of the present invention, a computer-readable medium having computer-readable signals stored thereon that define instructions that, as a result of being executed by a computer, instruct the computer to perform a method for verifiably determining an output while preserving secrecy of inputs and calculations thereon is provided. The method comprises calculating at least one output according to a predetermined calculation from at least one input submitted by at least one participant, translating a value in the predetermined calculation into a randomized representation of the value, wherein the randomized representation comprises at least two components and the at least two components determine the value through a function, publishing commitments to the at least two components of the randomized representation, revealing a portion of the randomized representation in response to a verification request, and enabling verification of the calculation of the at least one output using the revealed portion of the randomized representation. According to one embodiment of the present invention, the predetermined calculation includes at least one operation of addition, subtraction, multiplication, establishing an inequality between values, and exponentiation. According to another embodiment of the invention, the act of calculating includes an act of performing the at least one operation on the randomized representation of the value to determine the output. According to another embodiment of the invention, the act of enabling verification of the calculation includes using the published commitments.

According to another embodiment of the invention, the method further comprises an act of submitting, by a participant, an input, and a commitment to the input, and wherein the act of translating the value includes an act of translating, by the participant, the input into a randomized representation of the input, wherein the randomized representation of the input comprises at least two components and the at least two components determine the input through a function. According to one embodiment of the present invention, the at least two components are a pair of components. According to another embodiment of the invention, the pair of components determine the value through at least one of the operations of addition, subtraction, multiplication, and exponentiation on the pair of values. According to another embodiment of the invention, the randomized representation of the value in the calculation comprises a sum of the at least two components of the randomized representation. According to another embodiment of the invention, the sum of the at least two components is further represented as a randomized representation of the sum, comprising at least two components. According to another embodiment of the invention, the act of revealing a portion of the randomized representation includes revealing one value of the pair of values.

According to another embodiment of the invention, the commitments to the at least two components are binding and concealing. According to another embodiment of the invention, the method further comprises an act of digitally signing published commitments with digital signatures. According to another embodiment of the invention, the method further comprises an act of enabling verification of the digital signatures. According to another embodiment of the invention, the method further comprises an act of translating a value in the calculation into a plurality of randomized representations of the value.

According to one embodiment of the present invention, the method further comprises an act of generating a randomized representation of zero, wherein the randomized representation of zero comprises at least two components, wherein the at least two components recover the original value upon application of a function, and wherein the act of translating a value in the calculation into a randomized representation of the original value includes an act of employing the randomized representation of zero in generating randomized representations of calculation values. According to another embodiment of the invention, the method further comprises an act of revealing the at least two components of the randomized representation of zero in response to a request for verification. According to another embodiment of the invention, the method further comprises an act of enabling the verification of the randomized representation of zero.

According to another embodiment of the invention, the act of calculating the output based on received inputs includes and act of performing multiple calculations as single operations to reduce the randomized representations required. According to another embodiment of the invention, the act of enabling the verification of the calculation further comprises an act of permitting verification of at least one of a consistent representation of the input, a correct representation of zero, a correct representation of an addition with zero, a correct representation of an addition operation in the predetermined calculation, a correct representation of a multiplication operation in the predetermined calculation, a correct representation of an exponentiation operation in the predetermined calculation. According to another embodiment of the invention, the method is performed by a secure processor operatively connected to an independent secure co-processor that generates random values incorporated into at least one random representation of the value in the predetermined calculation.

According to one aspect of the present invention, a method for verifiably determining a winning bidder while preserving secrecy of other bids is provided. The method comprises calculating, according to announced rules, a winning bidder based on received bids from participants, translating a value in the calculation into a randomized representation of that value, wherein the randomized representation comprises at least two components and the at least two components determine the value through a function, publishing commitments to the at least two components of the randomized representation, revealing a portion of the randomized representation in response to a verification request, and enabling verification of the calculation of the winning bidder using the revealed portion of the randomized representation. According to one embodiment of the present invention, the calculation includes at least one operation of addition, subtraction, multiplication, and establishing an inequality between values. According to another embodiment of the invention, the act of enabling verification of the winning bidder includes using the published commitments. According to another embodiment of the invention, the method further comprises an act of submitting, by a bidder, a bid, and a bid commitment, and wherein the act of translating the bid value includes an act of translating, by the bidder, the bid into a randomized representation of the bid, wherein the randomized representation of the bid comprises at least two components and the at least two components determine the bid through a function. According to another embodiment of the invention, the at least two components are a pair of components. According to another embodiment of the invention, the pair of components determine the value through at least one of the operations of addition, subtraction, and multiplication on the pair of components. According to another embodiment of the invention, the act of revealing a portion of the randomized representation includes revealing one component of the pair of components.

According to one embodiment of the present invention, the commitments to the at least two components are binding and concealing. According to another embodiment of the invention, the method further comprises an act of digitally signing published commitments. According to another embodiment of the invention, the method further comprises an act of enabling the verification of the digital signatures. According to another embodiment of the invention, the method further comprises an act of transforming a value in the calculation into a plurality of randomized representations of the original value. According to another embodiment of the invention, the method further comprises acts of generating a randomized representation of zero, wherein the randomized representation of zero comprises at least two components, wherein the at least two components recover the original value upon application of a function; and wherein the act of translating a value in the calculation into a randomized representation of the original value includes an act of employing the randomized representation of zero in generating randomized representations of calculation values. According to another embodiment of the invention, the method further comprises an act of revealing the at least two components of the randomized representation of zero in response to a request for verification. According to another embodiment of the invention, the method further comprises an act of enabling the verification of the randomized representation of zero. According to another embodiment of the invention, the act of calculating a winning bidder based on received bids from participants, includes performing multiple calculations as single operations to reduce the randomized representations required. According to another embodiment of the invention,

According to one aspect of the present invention, a method for determining a participant winner from a group of participants, wherein the award to the participant winner may be verified while preserving the secrecy of the underlying determination of the participant winner is provided. The method comprises the acts of submitting, by the participant, an input to be evaluated according to predetermined rules, transforming the input into a randomized representation of the input, wherein the randomized representation of the input comprises at least two components that when joined by an operator reveal the original input, calculating a relationship on submitted inputs, by computing intermediate values according to the predetermined rules, wherein an intermediate value is represented as a randomized representation, and wherein the randomized representation comprises at least two components that determine the intermediate value through a function, determining an output indicative of the winning participant from the intermediate values, permitting verification of the calculation by any observer, by revealing at least one component comprising the randomized representation of the input, and at least one component comprising the randomized representation of the intermediate value.

According to one aspect of the present invention, a method for conducting a verifiable secrecy preserving computation of a winning bidder is provided. The method comprises submitting bids by participants, evaluating bids by an operator, determining a winning bidder using a verifiable secrecy preserving computation, publishing commitments to the components, wherein the commitments are binding and concealing, publishing at least one component value, verifying the determination of a winning bidder using the published component values, wherein the secrecy preserving computation further comprises the acts of translating the values used in the computation into a randomized representation of the values, wherein the randomized representation of the values comprises at least two components, and generating an output associated with the winning bidder. According to one embodiment of the present invention, the at least two component values comprise a pair of values, and the act of publishing at least one component value comprises publishing one half of the pair of values. According to another embodiment of the invention, the method further comprises an act of requesting, by a verifier, the revelation of the value of the at least one component value, and the act of publishing the at least one component value occurs in response to the request.

According to another embodiment of the invention, the act of translating the values used in the computation further comprises the acts of translating a bid submitted by the participant into a randomized representation of the submitted bid, wherein the randomized representation comprises at least two components, and translating at least one intermediate calculation in the computation into a randomized representation of the at least one intermediate calculation, wherein the randomized representation comprises at least two components. According to another embodiment of the invention, the act of translating the values used in the computation, further comprises an act of translating the output of the computation into a randomized representation of the intermediate calculation, wherein the randomized representation comprises at least two components, and wherein the output of the computation is associated with the winning bidder.

According to one aspect of the present invention, a computer implemented method for performing verifiable secrecy preserving computation, wherein the computation generates an output for determining a participant winner from among the computation participants is provided. The method comprises the acts of providing a function for determining an output value associated with a participant based on received input values, providing requirements for submission of input values, wherein the requirements include a commitment operation, and wherein the commitment operation is binding and concealing, submitting, by a participant, an input value and an input value commitment, translating the input value into at least two components, wherein the at least two components comprise a randomized representation of the input value and return the input value upon application of a function, publishing commitments to the at least two components, performing a computation on transformed input values, wherein the act of performing the computation further comprises an act of representing an intermediate calculation value as at least two component values, wherein the at least two component values comprise a randomized representation of the intermediate calculation value and return the intermediate calculation value upon application of a function, and the method further comprises the acts of publishing commitments to the at least two component values, publishing at least one of the at least two components and at least one of the at least two component values, and enabling verification of the determined output using the published at least one of the at least two components and at least one of the at least two component values.

According to one aspect of the present invention, a computer implemented method for performing verifiable secrecy preserving computation is provided. The method comprises the acts of submitting, by a participant, an input value and an input value commitment, translating the input value into at least two components, wherein the at least two components return the input value upon application of a function, validating the submitted input value, the input value commitment, the at least two components, and commitments to the at least two components, publishing the commitments to the at least two components, calculating intermediate values from the at least two components, verifying the intermediate values, generating an output value based at least in part on the at least two components, and the intermediate values, and enabling verification of the output value. According to one embodiment of the present invention, the method further comprises an act of repeating the translation of the input value into at least two components, until a predetermined number of translations are generated for each input value. According to another embodiment of the invention, the method further comprises an act of generating commitments to the translations. According to another embodiment of the invention, the method further comprises an act of submitting the translations for validation.

According to one aspect of the present invention, a computer-implemented method for enabling participants in a straight line computation to validate a secrecy preserving proof of correctness of an output of the computation based on, at least in part, received values submitted by the participants is provided. The method comprises generating, by a participant, an input value and a translation of the input value into at least two components, wherein the at least two components are used to retrieve the input value, submitting the input value, a commitment to the input value, the at least two components, and a commitment to each component, publishing valid commitments to each component, performing a straight line computation on the input values to yield an output value, wherein the act of performing the straight line computation on the input values includes an act of translating a computation value into at least two components and an act of posting commitments to the at least two components, providing for verification of the computation using the published commitments to the at least two components and revealing at least one value of the at least two components.

According to one aspect of the present invention, a method for performing verifiable secrecy preserving computation is provided. The method comprises the acts of providing a function for determining an output value based, at least in part, on received input values, translating function values into at least two components, performing calculations on the input values using translations to represent the calculation values, committing to the representations using a commitment function and signature, and verifying the correctness of the calculations by revealing the values for at a portion of the translation for a calculation value. According to one embodiment of the present invention, the commitment function is concealing and binding.

### DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. The drawings are presented by way of illustration only and are not intended to be limiting. In the drawings,

FIG. 1 is a flow chart of a process for performing a verifiably correct computation according to one embodiment of the invention;

FIG. 2 is a flow chart of a process for performing a verifiably correct computation according to one embodiment of the invention;

FIG. 3 is a block diagram of a system for conducting a verifiably correct computation according to one embodiment of the present invention;

FIG. 4 is a block diagram of a system for conducting a verifiably correct computation according to one embodiment of the invention;

FIG. 5 is a block diagram of a system for conducting a verifiably correct computation according to one embodiment of the invention;

FIG. 6 is a flow chart of a process for performing a verifiably correct auction according to one embodiment of the invention;

FIG. 7 is a flow chart of a process for providing secure random values used in verifiably correct secrecy preserving computation according to one embodiment of the invention;

FIG. 8 is a flow chart of a process enabling verification of calculations while preserving secrecy according to one embodiment of the invention; and

FIG. 9 is a block diagram of a system for conducting a verifiably correct computation according to one embodiment of the invention.

### DETAILED DESCRIPTION

This invention is not limited in its application to the details of construction and the arrangement of components set forth in the following description or as illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items

Model Embodiments

In one embodiment, computations are performed with elements of a finite field Fₚ, where p is a moderately large (for example 128 bits) prime. Although larger prime numbers are used in some embodiments, and smaller primes used in some others. For ease of notation, elements of Fₚ is denoted by lower case Roman letters x, y, z, u, v, w, etc. and are referred to as numbers. In another embodiment, computations with numbers are, performed mod p.

In one embodiment, let x₁, . . . ,xₙ be elements of Fₚ, the elements may sometimes be referred to as inputs. In one example, a straight line computation (SLC) on these inputs is a sequence of numbers

x₁, . . . ,xₙ,xₙ₊₁, . . . ,x_{L} (1)

where for every n<m≦L, there are two indices i, j<m such that xₘ=xᵢ∘xⱼ where ∘ is one of +, −, ×, or the exponentiation operation.

The number x_{L} is called the output or result of the straight line computation. Clearly x_{L} is the value of a polynomial function ƒ(x₁, . . . ,xₙ) of the input values.

According to one aspect, the notion of a SLC is generalized to involve addition and multiplication by publicly known constants from Fₚ, and in one embodiment further includes the inverse operation xₘ=xᵢ⁻¹, allowed when xᵢ≠0. The results discussed below with respect to certain embodiment, may also be extended to the general case as well.

In one embodiment, assume n parties P₁, . . . ,Pₙ, respectively hold the input values x₁, . . . ,xₙ. According to one aspect, the parties wish to perform the straight line computation (1) on the input values and obtain the result x_{L}=ƒ(x₁, . . . ,xₙ). In another aspect, they want to accomplish this by a secrecy preserving method, revealing nothing about the input values or the intermediate values in the computation, beyond what is implied by the value of the result x_{L}. For example, if x_{L}=x₇−x₁₁ and the value of x_{L} is revealed to be 0, then it follows that x₇=x₁₁. According to another aspect, the parties, and perhaps others, want to be certain that the revealed value x_{L} is the correct result of the straight line computation (1). Thus the protocol must provide a secrecy preserving proof of correctness.

These requirements give rise to the following definitions, used in some embodiments.
Definition 1 An Evaluator-Prover (EP )for the SLC (1) is an entity which, upon receiving input values x₁, . . . ,xₙ, outputs the value x_{L}=ƒ(x₁, . . . ,xₙ) and engages in a proof of correctness to certify correctness of the result value.
Definition 2 An Evaluator-Prover is secrecy preserving if the proof of correctness does not reveal anything about the input values or the intermediate values in the SLC (1) except for the information implied by the output value x_{L}=ƒ(x₁, . . . ,xₙ). An EP is trusted if it outputs or reveals only x_{L} and the proof of correctness.

In a real world example of a trusted Evaluator-Prover, the EP is an auctioneer AU. The input values to the computation are the values of bids submitted by parties participating in the auction. For the application to some particular auction embodiments, comparisons such as “xᵢ≦xⱼ” are required. The discussion below describes how a secrecy preserving proof of correctness can be extended to deal with comparisons.

There are known protocols that ensure that the auctioneer cannot reveal any bid before the closing of the auction or change or suppress bids after the closing of the auction, they are used in at least some embodiments. In one example, the extent of trust placed in the AU is that he will not reveal any information about the bids except for the outcome of the auction and what is implied by announcement of the outcome. For example, in a Vickrey auction where the item goes to the highest bidder at the price bid by the second highest bidder, the announcement will reveal the identity of the winner. Whether the winner's payment will be revealed depends on the announced rules of the auction. In some embodiments, the protocols can also enforce secrecy of that payment, if so desired.

According to one aspect, the rationale for a partial trust model is that illegally and selectively leaking out bid values before the closing of the auction, or announcing a false auction result, can lead to collusions greatly benefiting some bidders and the auctioneer. Some embodiments completely prevent such malfeasance. On the other hand, leaking out bid values after the end of an auction helps bidders who received such information in strategizing for future similar auctions. The value of this information advantage is, however, relatively limited. Consequently the auctioneer, who has his business reputation to guard, has a substantial incentive not to leak out information after the conclusion of auctions. In some embodiments, the incentive guard one's business reputation is relied on, in some others, it is not.

In another embodiment, a model implements the trusted Evaluator-Prover by a secure co-processor. In one example, the secure processor is a closed device for which all outputs are publicly observable. The processor is trusted not to output any information beyond that specified by the protocols. According to one aspect, the published proof of correctness assures the participants that the output result is really the correct result of the SLC. Example implementations of this model, dealing with some of the subtleties it entails, are discussed further below.

In order to enable secrecy preserving proofs of correctness according to one embodiment, the parties P₁, . . . ,Pₙ and the Evaluator-Prover represent the inputs and the intermediate values in the SLC by pairs of numbers from Fₚ. In the following description, capital letters X, Y, Z, U, V, etc. to denote elements of Fₚ×Fₚ, i.e. pairs of numbers from Fₚ.
Definition 3 U=(u₁,u₂) represents uε Fₚ if u=u₁+u₂. Denote u₁+u₂ by val(U). A participant in the protocol creates a random representation U of a number u by randomly choosing u₁ from Fₚ and setting U to (u₁,u−u₁). Clearly val(U)=u.

In one particular example, a random representation Z of zero is obtained by randomly choosing z from Fₚ and setting Z to (z,−z). At the bit level, Kilian in “A note on efficient zero-knowledge proofs and arguments,” In Proceedings of STOC'92, pages 723-732, 1992 (inspired by unpublished work of Bennett and Rudich) used a similar representation scheme with “pair blobs” to represent binary values (see also Brassard et al., “Minimum Disclosure Proofs of Knowledge,” in Journal of Computer and System Sciences, vol. 37, pages 156-189, 1988).

According to one aspect, a high-level idea of a protocol is that a verification of an operation in the SLC is implemented by randomly selecting and revealing either the first or the second coordinates of the pairs representing the numbers in question. The idea is that revealing just one coordinate of a pair reveals nothing about the value of the pair. Further embodiments and implementations are discussed below.
Translations. In one embodiment, the secrecy preserving proof of correctness of the published result of the SLC is achieved by a process of “translation” of x₁ , . . . ,x_{L} into a sequence TR(SLC) of at most O(L) pairs. The first n pairs in the translation, denoted X₁, . . . ,Xₙ, represent the input values x₁, . . . ,xₙ. The pairs Xₙ₊₁, . . . ,X_{L-1} represent intermediate values used in the SLC, and in verifying the correctness of the SLC according to some embodiments. In an example, the final pair in the translation represents the output x_{L} of the computation, i.e. the value of this final pair is x_{L}=ƒ(x₁, . . . ,xₙ).

In one embodiment, the computations xₘ=xᵢ∘xⱼ, where o is one of +,−,×, or the exponentiation operation, are translated in a natural way into operations on pairs U=(u₁,u₂), V=(v₁,v₂), W=(w₁,w₂) representing xₘ,xᵢ,xⱼ. For example, x=xᵢ+xⱼ is translated into W=U+V, i.e. ordinary vector addition. Subtraction is entirely similar to addition, but the translation of xₘ=xᵢ×xⱼ is slightly more complicated and is described in more detail below. Exponentiation can be similarly performed using the multiplication operation and repeated squaring One should appreciate that translation into pairs is not the only possible translation, other multiples may be used.
Aspects. In another embodiment, to achieve a probability less than 2^{-k} of accepting a false result of the SLC, K=0(k) randomly created translations of the SLC are required. (As described below in one example, K=γk is sufficient where the constant

$$γ {=}^{def} 90. )$$

As discussed in greater detail below with respect to some embodiments, in the verification procedure the Verifier randomly samples some of these K translations and verifies various “aspects” of the EP's computation in the selected translations. As described, these different “aspects” capture different elements that are required in some embodiments of the overall computation to be correct: one aspect deals with consistent representation of the n input values, one deals with correctness of the random representations of zero mentioned above, one deals with correctness of addition steps, and so on.

Inputting and Verifying the Values x₁, . . . ,xₙ in Some Embodiments

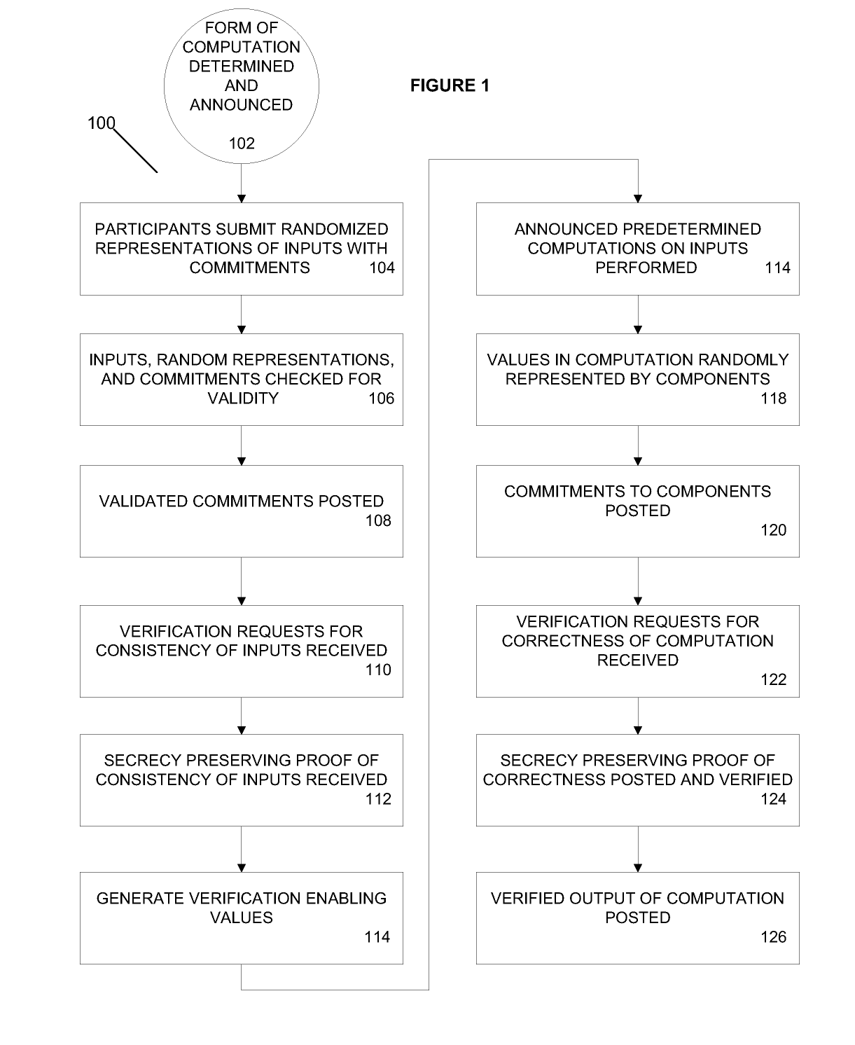

In some embodiments, a commitment function COM(•) and digital signatures for the parties P₁, . . . ,Pₙ. are required. With reference to FIG. 1, example process 100 for performing a verifiable secrecy preserving computation establishes the form of the computation, by detailing such requirements, as well as other features' of the computation at 102. These features include the SLC used, security parameters, etc. In the context of an auction, the form describes the information that is permitted to be revealed at the conclusion of the auction, bid requirements, etc.

In one example, each party Pₘ creates K random representations Xₘ⁽¹⁾=(a₁,b₁), . . . ,Xₘ^{(K)}=(a_{K},b_{K}) of his input value xₘ. The participant privately sends xₘ, SIGNₘ(COM(xₘ)), and all K quadruples aⱼ, bⱼ, SIGNₘ(COM(aⱼ)), SIGNₘ(COM(bⱼ)) to the Evaluator-Prover EP at 104.

The EP verifies that xₘ=val(Xₘ^{(j)})=aⱼ+bⱼ for 1≦j≦K, verifies all the 4K+1 commitments, and verifies all digital signatures at 106. If any verification fails, then according to the protocol, the EP rejects Pₘ's input value.

After all inputs were accepted by the EP, he posts, for every party Pₘ, all the 2K signed commitments SIGNₘ(COM(aⱼ)), SIGNₘ(COM(bⱼ)), 1≦j≦K, to the representations of the value xₘ at 108.

In some embodiments, every Verifier can check and verify all the digital signatures and thereby verify that the respective commitments were made by the parties P₁, . . . ,Pₙ. At step 110, verification requests for consistency of input values are received, and at 112, a secrecy preserving proof of consistency of inputs is received in response to verification request. The secrecy preserving proofs, in one example, are for the claim by the EP that for every Pₘ all committed-to pairs Xₘ⁽ⁱ⁾ represent the same value are discussed. According to one embodiment, the method establishes a useful approximation to the validity of the claim.

In one example, consider two pairs U=(u₁,u₂) and V=(v₁,v₂), where commitments COM(u₁), COM(u₂), COM(v₁), COM(v₂) are posted, as in one example, at step 108. Val(U)=val(V) if and only if (u₁−v₁)+(u₂−v₂)=0. To prove equality of values of U and V, the EP posts d₁ and d₂, for example as part of step 112, which are claimed to be respectively the differences (u₁−v₁) and (u₂−v₂). The Verifier randomly chooses an index cε {1,2} and requests that EP reveal the values committed to by the posted COM(u_{c}) and COM(v_{c}) for example, at step 110. One should appreciate the invention is not limited to the ordering of process 100. For example, steps 110-112 may occur in different order.

If d₁+d₂≠0 or u_{c}−v_{c}≠d_{c}, then the Verifier rejects the claim that val(U)=val(V). It is clear that if actually val(U)≠val(V), then the probability of the Verifier accepting the claim of equality of values is at most ½.

Consider for one embodiment two arrays of pairs T₁=U₁, . . . ,Uₙ and T₂=V₁, . . . ,Vₙ where all commitments to components of all pairs are posted, and the claim is being made that

val(Uₘ)=val(Vₘ) for 1≦m≦n. (2)

In one example, the Verifier uses the above verification procedure simultaneously for all couples Uₘ,Vₘ of pairs, employing the same randomly chosen c for all couples. If the claim is not true, then the probability of acceptance by the Verifier is at most ½.

Arrays T₁ and T₂ are value-consistent if (2) holds true.

In another example, let T⁽ⁱ⁾=X₁⁽ⁱ⁾, . . . ,Xₙ⁽ⁱ⁾, 1≦i≦K, be the K arrays of pairs of elements from Fₚ, where Xₘ⁽ⁱ⁾ is the i-th pair submitted to EP by Pₘ. All the 2n commitments to the components of the pairs in the array T⁽ⁱ⁾ are denoted by COM(T⁽ⁱ⁾). According to the procedure of submitting input values, all those commitments were posted by the EP, in one example at step 108 of process 100. The EP claims that these are commitments to K pair-wise value-consistent arrays. Denoting by T⁽ⁱ⁾[m] the m-th pair in the array T⁽ⁱ⁾, this means that for every m, all values val(T⁽ⁱ⁾[m]) are equal.

For one example, fix

$$α {=}^{def} 5.5 .$$

To validate the EP's claim, the Verifier chooses a sequence of 2αk different superscripts (in other words αk pairs of superscripts (i, j) used to identify the arrays T⁽ⁱ⁾, T^{(j)} to be compared) (i₁,j₁), . . . , (i_{αk},j_{60 k}) uniformly at random from {1, . . . , K}. For each value 1≦s≦αk, the Verifier obtains from the EP a proof, as detailed above, that the arrays T⁽ⁱ^{ₛ}⁾ and T^{(j}^{ₛ}⁾ are value-consistent for example at 112. If all proofs succeed then the Verifier accepts.
Theorem 4 If the EP's claim that all pairs of arrays (given by their posted commitments) are value-consistent is true, then EP can obviously pass the verification.

In one embodiment, fix

$$β {=}^{def} 2 / 3.$$

To see that this is an effective verification strategy, suppose that for every superscript iε {1, . . . ,K}, fewer than βK=βγk=60 k of the arrays are value-consistent with the array T⁽ⁱ⁾. The choices of the pairs of superscripts are viewed as being done sequentially, i.e. in the (s+1)-st round the pair (iₛ₊₁,jₛ₊₁) is chosen from the remaining K−2s superscripts.

For 0≦s<αk, in the (s+1)-st round, regardless of the outcomes of previous rounds and of the value chosen for iₛ₊₁, there are at most βγk=60 k superscripts that are value-consistent with iₛ₊₁ out of the remaining pool of γk−2s≧γk−2αk=79 k possibilities for jₛ₊₁. So the (s+1)-st pair chosen is value-consistent with probability at most

$$\frac{β γ k}{γ k - 2 α k} = \frac{60}{79} ,$$

and thus is not value-consistent with probability at least

$$\frac{γ k - 2 α k - βγ k}{γ k - 2 α k } = \frac{γ - 2 α - βγ}{γ - 2 α} = \frac{19}{79} .$$

If the (s+1)-st pair chosen is not value-consistent, then the verification survives the (s+1)-st round with probability at most ½. So in each of the αk rounds, regardless of what has happened before, the probability that the verification survives that round is at most

$$1 - \frac{γ - 2 α - βγ}{2 γ - 4 α} = ( 1 - \frac{19}{158} ) .$$

Consequently, the overall probability that the Verifier accepts is at most

$${( 1 - \frac{γ - 2 α - βγ}{2 γ - 4 α} )}^{α k} = {( 1 - \frac{19}{158} )}^{5.5 k} .$$

### Since

$$0.4942 \approx {( 1 - \frac{19}{158} )}^{5.5} < 1 \text{/} 2 ,$$

theorem 5 is proved true.
Theorem 5 Suppose that for the sequence of arrays T⁽¹⁾, . . . ,T^{(K)}, where each array comprises n pairs of numbers from Fₚ, there is no subset S with |S [symbol] βK such that every two arrays in S are value-consistent. Then the probability that the Verifier accepts the proof of value-consistency of all couples of arrays in the sequence is at most ½^{k}.

The Translation Process

Once the input values were submitted in pair representations and accepted by the EP as above, the EP prepares K translations of the SLC (1) as follows. To avoid cumbersome superscript/subscript notation, the following description considers one array T=X₁, . . . ,Xₙ of representations of the n submitted input values.

In the computation (1), an input or intermediate result xᵢ is in general be involved in several subsequent operations xᵢ∘xⱼ=xₘ. To enable a secrecy preserving proof of correctness, prepared in the translation, once Xᵢ (a representation of xᵢ) was inputted or computed, are as many new random representations of val(Xᵢ) as there are involvements of xᵢ in subsequent computations in the SLC (1), in one example as part of step 114, of process 100, in order to verifiably perform the predetermined computation on inputs, at 116, in a secrecy preserving manner.
Definition 6 Let X be a pair. A new random representation X′ of x=val(X) is obtained by randomly choosing z from Fₚ and setting X′ to X+(z,−z), i.e. X′=X+Z, where Z is a random representation of 0.

In one embodiment, the EP starts by extending the array X₁, . . . ,Xₙ by Z₁, . . . ,Zₛ each of which is an independent random representation of 0, where s=O(L) is the total number of new representations that are created in the translation process. In one example, the array is extended as part of step 114.

If x₁ occurs in s₁ subsequent computations in (1) (where a computation x₁∘x₁ is counted as having two occurrences of x₁), then the EP extends the translation array by Y₁, . . . ,Yₛ_{₁}. Here Yⱼ=X₁+Zⱼ, 1≦j≦s₁. The other inputs X₂, . . . ,Xₙ give rise to additional new representations Yₛ_{₁}₊₁, . . . ,Yₜ in a similar way. Each new representation employs the next unused Zⱼ.

In one example, consider the operation xₙ₋₁=xᵢ∘xⱼ of (1), where on the right hand side are the input values. In the case where the operation ∘ is the + operation, to translate this operation, EP chooses from the sequence Y₁, . . . ,Yₜ the first new representations of xᵢ and xⱼ. In this example these representations are (to avoid double indices) Y′=(u₁,v₁) and Y″=(u₂,v₂). The translation of xₙ₋₁=xᵢ+xⱼ is

Xₙ₊₁=Y′+Y″=(u₁+u₂,v₁+v₂). (3)

Next EP creates a first new representation NXₙ₊₁ of val(Xₙ₊₁), which of course equals xᵢ+xⱼ, by employing Zₜ₊₁, the next unused representation of 0:

NXₙ₊₁=Xₙ₊₁+Zₜ₊₁ (4)

Now, if xₙ₊₁ is used sₙ₊₁ times in the SLC (1), the EP creates Sₙ₊₁ new random representations of xₙ₊₁ by:

Yₜ₊₁=NXₙ₊₁+Zₜ₊₂,. . . ,Yₜ₊ₛ_{ₙ₊₁}=NXₙ₊₁+Zₜ₊₁₊ₛ_{ₙ₊₁} (5)

In this example, new representations (5) use the first new representation NXₙ₊₁, rather than the representation Xₙ₊₁ of xₙ₊₁. In one embodiment, the values in the computation are randomly represented by components according to the new representations discussed above, at step 118. According to one aspect, the reason for using new representations relates to the proof for the secrecy preserving nature of the proof of correctness.

In another case, where xₙ₊₁=xᵢ×xⱼ, the translation is more complicated. Let again Y′=(u₁,v₁) and Y″=(u₂,v₂) be the new representations of xᵢ and xⱼ, as above. In one embodiment, obtain the representation X_{n 1} of xₙ₊₁=xᵢ×xⱼ via four intermediate steps:

X′ₙ₊₁=(u₁v₁,0)+Zₜ₊₁ (6a)

X″ₙ₊₁=(u₁v₂,0)+Zₜ₊₂ (6b)

X′″ₙ₊₁=(u₂v₁,0)+Zₜ₊₃ (6c)

X″″ₙ₊₁=(u₂v₂,0)+Zₜ₊₄ (6d)

Xₙ₊₁=X′ₙ₊₁+X″ₙ₊₁+X′″ₙ₊₁+X″″ₙ₊₁. (6e)

It is clear from the distributive law that

val(Xₙ₊₁)=val(U′)×val(U″)=xᵢ×xⱼ=xₙ₊₁.

The first new random representation NXₙ₊₁ and the subsequent new random representations of xₙ₊₁ are obtained as in (4) and (5), using new successive random representations Z_{q} of 0 from the given list.

In one embodiment, the translation process of the SLC (1) now proceeds inductively, operation by operation, similarly to the translation of xₙ₊₁=xᵢ∘xⱼ, using new representations of operands and of zero at every stage.

The outcome of the translation process for the case xₙ₊₁=xᵢ+xⱼ is:

TR=X₁, . . . ,Xₙ,Z₁, . . . ,Zₛ,Y₁, . . . ,Yₜ,Xₙ₊₁, NXₙ₊₁,Yₜ₊₁, . . . ,Yₜ₊ₛ_{ₙ₊₁}, . . . ,X_{L}. (7a)

According to one embodiment, X₁, . . . ,Xₙ are representations of the input values; Z₁, . . . ,Zₛ are random representations of 0; Y₁, . . . ,Yₜ are new random representations of the input values; Xₙ₊₁ is a representation of xₙ₋₁, obtained as in (3); NXₙ₊₁, is a next random representation of xₙ₊₁, obtained as in (4); Yₜ₋₁, . . . ,Yₜ₊ₛ_{ₙ₊₁} are further random representations of xₙ₊₁, obtained as in (5), and X_{L} is a representation of the output x_{L}.

In the case Xₙ₊₁=xᵢ×xⱼ, the translation reflects:

TR=X₁, . . . ,Xₙ,Z₁, . . . ,Zₛ,Y₁, . . . ,Yₜ, X′ₙ₊₁, . . . ,Xₙ₊₁^{†′″},Xₙ₊₁,NXₙ₊₁, Yₜ₊₁, . . . ,Yₜ₊ₛ_{ₙ₊₁}, . . . ,X_{L} (7b)

where X′ₙ₊₁, . . . ,Xₙ₊₁^{†′″},Xₙ₊₁ are obtained as in (6a)-(6e).

The notation for some embodiments, is such that in a translation TR, the pairs X₁, . . . ,Xₙ,Xₙ₊₁, . . . ,X_{L} correspond to the values x₁, . . . ,xₙ,xₙ₊₁, . . . ,x_{L} in the SLC (1). According to some embodiments, it can now be shown that Xⱼ represents the corresponding values xⱼ.
Theorem 7 If val(Xᵢ)=xᵢ for 1≦i≦n, then val(Xⱼ)=xⱼ for 1≦j≦L.
Proof: In one example, consider xₙ₊₁=xᵢ∘xⱼ. The construction of Xₙ₊₁ in the translation by (3) in the case of ∘=+, and by (6a)-(6e) in the case of ∘=×, together with val(Zₜ)=0 for all 1≦t≦s, implies that val(Xₙ₊₁)=xₙ₊₁. The proof now proceeds by induction on j.

Verifying Aspects of Translations

Recall that each of the parties P₁, . . . ,Pₙ has created and submitted to EP K representations of their input values. In one example process, this occurs at step 104. In one embodiment, the EP verifies the digital signatures, the commitments, and the fact that each party Pₘ has submitted K representations of the same value xₘ. In an example process this occurs at step 106.

EP creates K translations TR^{(j)}, 1≦j≦K, of the SLC (1):

TR^{(j)}=X₁^{(j)}, . . . ,Xₙ^{(j)},Z₁^{(j)}, . . . ,Zₛ^{(j)}, Y₁^{(j)}, . . . ,Yₜ^{(j)}, . . . ,Xₙ₊₁^{(j)},NXₙ₊₁^{(j)}, Yₜ₊₁^{(j)}, . . . ,Yₜ₊ₛ_{ₙ₊₁}^{(j)}, . . . ,X_{L}^{(j)}. (8)

In an example process, the translations are created at part of steps 114-118. According to some embodiment, the array X₁^{(j)}, . . . ,Xₙ^{(j)}, consisting of the j-th input pairs submitted to EP by P₁, . . . ,Pₙ, is extended by EP to TR^{(j)} in the manner detailed above.

The EP now posts all the signed commitments to (coordinates of) the input pairs, and commitments to (coordinates of) all the other pairs in all translations. The commitments to all the other pairs in all translations are posted, for example, at step 120. The EP claims that the posted commitments are to K correct translations of the SLC on the same input values. If that is indeed the case he is able to respond correctly to all challenges by the Verifier. After revelation of the commitments to all the other pairs in all translations, a verification request for correctness of the computation is received at 122. In response, a secrecy preserving proof of correctness is published an verified, at 124.

Thus the proof method according to some embodiments is complete. All true statements are provable. In one example, the verified output of the computation is posted, in conjunction with the proof at 126.

In one embodiment, the Verifier verifies the correctness of nine of what can loosely be called “aspects” of the posted translations. Examples of aspects to be verified are discussed below.

Provable Aspects of Some Embodiments
Aspect 0. As demonstrated above, by randomly choosing αk=5.5 k pairs of translations, the Verifier verifies with probability of error smaller than 2^{-k} that for at least βK=2K/3 translations, for every party Pₘ, all submitted pairs represent the same value xₘ. (See Theorem 5.) In one example, consider unique xₘ to be Pₘ's input to the SLC.

According to one embodiment, every translation involved in the above verification is discarded and is not used in the following verifications of other aspects of the proof. In one example, aspects 1, . . . ,8 are verified for a given fixed translation, denoted TR, as discussed below.
Aspect 1. For a posted translation TR, (7a) or (7b), TR is correct with respect to representations of 0, if for all 1≦j≦s val(Zⱼ)=0.

In one embodiment, to verify that TR is correct in Aspect 1, the Verifier requests of EP to reveal (de-commit) all coordinates of all pairs Zⱼ and checks that for each pair the coordinates sum up to 0. In one example, aspect 1 is verified as part of step 122-124.
Aspect 2. In one embodiment, TR is correct in Aspect 2 if every computation of a new representation NXⱼ from a representation Xⱼ, in the manner of (4), is correct.

In another embodiment, to verify correctness in Aspect 2, Verifier randomly chooses cε {1,2} and presents c to EP. If c=1 then EP reveals (de-commits) the first coordinate in all computations of NXⱼ=Xⱼ+Zₑ₍ⱼ₎ within TR. The Verifier checks that the first coordinates of Xⱼ and Zₑ₍ⱼ₎ sum up to the first coordinate of NXⱼ. He rejects the whole proof if even one of these checks fails. The case c=2 is handled similarly.

Note that if a translation TR does not satisfy the condition Xⱼ+Zₑ₍ⱼ₎=NXⱼ for all indices j, then it will be accepted by the Verifier with probability at most ½. In one example, aspect 2 is verified as part of step 122-124.
Aspect 3. TR is correct in Aspect 3 if all computations of the new representations Y₁, . . . ,Yₜ of the input-representations X₁, . . . ,Xₙ and all the further new representations of Xⱼ obtained from NXⱼ in the manner of (5) are correct.

In one example, all of these computations are of the form Y=Xⱼ+Z for the input value representations and Y=NXⱼ+Z for representations of intermediate results of the SLC, where in each case Z is a specific representation of 0 from the list in TR. So the Verifier has to verify the correctness of these addition operations. This is again done as in the verification of Aspect 2, with probability of error at most ½. In one example, aspect 3 is verified as part of step 122-124.
Aspect 4. TR is correct in Aspect 4 if all the translations of addition operations xₘ=xᵢ+xⱼ of the SLC, in the manner of (3), as well as all additions of the form Xₘ=Xₘ^{†}+ . . . +Xₘ^{†′″} arising in translations of multiplications (see (6e) where m=n+1), are correct.

In one embodiment, the Verifier has to check all equalities of the form Xₘ=Y′+Y″ and of the form Xₘ=Xₘ^{†}+. . . +Xₘ^{†′″} in the translation. This is again done by checking correctness of additions, with probability of error at most ½. In one example, aspect 4 is verified as part of steps 122-124.

According to another embodiment, aspects 5-8 deal with correctness of the translations of product computations xₘ=xᵢ×xⱼ. Let Xₘ be the representation of xₘ and Y′=(u₁,v₁) and Y″=(u₂,v₂), be respectively the representations of xᵢ and xⱼ in TR, used in the translation of the product computation. In one example, aspects 5-8 are verified as part of steps 122-124
Aspect 5. TR is correct in Aspect 5 if for all translations of product operations in the manner of (6a)-(6d), the equations

X′ₘ=(u₁v₁,0)+Z, (9)

where Z is a specific representation of 0 from the list in TR (a different Z for every m), are true.

In one example, the Verifier randomly chooses cε {1,2} and presents c to EP. If c=1 then EP reveals for all translations of products the first coordinates w of X′ₘ, z of Z, and u₁,v₁ of Y′,Y″. The presentation of c may occur as part of step 122, as a request for correctness of computation which is received by the EP. The EP posts proofs of correctness on, for example, aspects 1-8, which a verifier verifies at step 124. The verifier accepts only if w=u₁×v₁+z is true for all translations of product computations in SLC. If c=2 then EP reveals for all translations of products the second coordinates w′ of X′ₘ,z′ of Z. The verifier accepts only if w′=z′ is true for all translations of product computations in SLC. Clearly, if TR is not correct in Aspect 5, then the Verifier will accept with probability at most ½.

Aspects 6, 7 and 8 of a translation TR of the SLC deal with the correctness of the translations of Xₘ^{†′}, Xₘ^{†″} and Xₘ^{†′″} respectively, according to (6b), (6c) and (6d). In one example, they are defined, and are checked by the Verifier, in a way similar to the treatment of Aspect 5. In each case the probability of erroneous acceptance is at most ½. In one embodiment, aspects 6-8 are verified as part of steps 122-124.

Proof of Correctness and Error Probability

Putting together the verification procedures described above, described is an example of an overall proof of correctness of the result x_{L} of the SLC. In an example process 100, the result is posted at 126. In one embodiment, the SLC has a provable upper bound of ½^{k} for the probability of error.

In the first step of verification, the EP posts K translations of the SLC (1) in the form of commitments to all coordinates of the pairs in the translations.

Aspect 0 of the correctness of the translations TR^{(j)}, 1≦j≦K, is that the arrays X₁^{(j)}, . . . ,Xₙ^{(j)}, 1≦j≦K, of representations of the input values to the SLC are pair-wise value-consistent. The Verifier checks this by randomly choosing αk=5.5 k pairs of translations and performs the tests described above. As described in Theorem 5, if there are fewer than βK=2K/3=60 k translations with pair-wise value-consistent input value arrays, then the Verifier will accept the whole proof with probability less than ½^{k}.

Denoted by S₁ are the translations not involved in testing Aspect 0, and denoted by

$${K}_{1} {=}^{def} K - 2 α k$$

are the number of translations in S₁. Recalling that K=γk, then K₁=(γ−2α)k=79 k .

In one example, considered is the case in which at least βK of the original K translations have pair-wise value-consistent input value arrays. Since K=γk, at least βK−2αk=(βγ−2α)k=49 k of the K₁=(γ−2α)k=60 k translations in S₁ have pair-wise value-consistent arrays of inputs. The common values x₁, . . . ,xₙ represented by the pairs in those consistent arrays are, by definition, the input values of the SLC.

In one example, fix

$$δ {=}^{def} 29.$$

The verifications o the correctness of Aspects 1-8 of the translations in S₁ proceed as follows. The Verifier chooses a set of δk translations uniformly from S₁. For each translation TR^{(j)} of these δk, he randomly chooses an integer rε {1, . . . ,8} and a challenge cε {1,2} and performs a check for the correctness of TR^{(j)} in Aspect r on the posted response. The challenge response may take part of an example process 100, as part of steps 122-124. If any of the δk checks fail, then the Verifier rejects.

As described above with respect to verifying aspects of translations, if TR^{(j)} is incorrect in Aspect r, it will pass the test with probability at most ½. Consequently, if TR^{(j)} is incorrect in any one of the Aspects 1-8, it will fail its check with probability at least 1/16. This observation enables proof of the following:
Theorem 8 Fix

$$ɛ {=}^{def} 31.$$

Suppose that of the K₁=K−2αk=(γ−2α)k=79 k translations in S₁, fewer than εk translations are correct in all Aspects 1-8. Then the probability that all δk=29 k of the Verifier's checks succeed is smaller than ½^{k}.
Proof: In one example, view the δk choices from S₁ as being done sequentially, i.e. in the (s+1)-st round the translation is chosen from the remaining K₁−s translations. By assumption, for 0≦s<δk, in the (s+1)-st round, regardless of the outcomes of previous rounds, there are at most εk=31 k translations that are correct in all aspects 1-8 among the remaining (γ−2α)k−s≧(γ−2α−δ)k=50 k translations. So the (s+1)-st translation chosen is correct in all aspects with probability at most

$$\frac{ɛ}{γ - 2 α - δ} = \frac{31}{50} ,$$

and is incorrect in some aspect with probability at least

$$\frac{γ - 2 α - δ - ɛ}{γ - 2 α - δ} = \frac{19}{50} .$$

According to one aspect, this means that regardless of what has happened before, for each value 0≦s<δk, the verification survives the (s+1)-st round with probability at most

$$( 1 - \frac{γ - 2 α - δ - ɛ}{16 ( γ - 2 α - δ )} ) = ( 1 - \frac{19}{800} ) .$$

Consequently the overall probability that all δk=29 k of the Verifier's checks succeed is at most

$${( 1 - \frac{γ - 2 α - δ - ɛ}{16 ( γ - 2 α - δ )} )}^{δ k} = {( 1 - \frac{19}{800} )}^{29 k} .$$

### Since

$$0.4980 \approx {( 1 - \frac{19}{800} )}^{29} < 1 \text{/} 2 ,$$

the theorem is proved.

After performing the verifications of pairwise consistency of translations of input values and the verifications of the correctness of Aspects 1-8 of the translations, there remain

$${K}_{2} {=}^{def} {K}_{1} - δ k = ( γ - 2 α - δ ) k = 50 k$$

untouched translations. In one embodiment, the verifier now asks the EP to open all the commitments to the components of the pairs X_{L}^{(j)} in these K₂ translations. This occurs in one example as part of step 124. If now val(X_{L}^{(j)})=x_{L} for all these X_{L}^{(j)}, then the Verifier accepts x_{L} as the result of the SLC.

It is shown for some embodiments, there is an upper bound on the probability that the Verifier accepts a wrong value for the output xₘ of the SLC (1):
Theorem 9 Assume that the Verifier accepted all components of the proof of correctness, i.e. the proof of pair-wise value-consistency of the arrays of inputs values of the K translations, the proofs of correctness of the translations in respect to Aspects 1-8, and the agreement of all revealed values of the pairs X_{L}^{(j)}. Then the common revealed x_{L}=val(X_{L}^{(j)}) is the output value of the SLC with probability of error smaller than 3/2^{k}.
Proof: It was shown above, in one embodiment, that the successful verification of Aspect 0—the pair-wise value-consistency of the representations of the input values—assures with probability of error at most ½^{k} that at least β=⅔ fraction of the K=γk=90 k translations are pair-wise value-consistent with respect to the arrays of the n input values. Thus at least K₁−(1−β)K=(γ−2α)k−(1−β)γk=(βγ−2α)=49 k of the remaining K₁=(γ−2α)k=79 k translations are pair-wise input-value consistent. This defines a unique sequence of common values x₁, . . . ,xₙ represented by the pairs in these consistent arrays (which form a majority of the K₁ remaining arrays); these values are, by definition, the input values of the SLC.

By Theorem 8, if the translations in S₁ passed the tests on the randomly chosen δk=29 k translations, then with probability of error smaller than ½^{k}, more than εk=31 k of the translations are correct in all Aspects 1-8. This implies that among the at least (βγ−2α)k=49 k pair-wise input-value consistent translations in S₁, at least (βγ−2α)k+εk−(γ−2α)k=(ε−γ(1−β))k=k translations are also correct in all aspects, with probability of error at most ½^{k}. Let S₃ denote any fixed set of k translations that are correct in all aspects.

The probability that the δk=29 k translations randomly chosen from S₁ include all k translations in S₃ is

$$\frac{( \frac{{K}_{1} - k}{δ k - k} )}{( \frac{{K}_{1}}{δ k} )} = \frac{δ k ( δ k - 1 ) … ( δ k - k + 1 )}{{K}_{1} ( {K}_{1} - 1 ) … ( {K}_{1} - k + 1 ) } < {( \frac{δ k}{{K}_{1}} )}^{k} \\ = {( \frac{δ}{γ - 2 α} )}^{k} \\ = {( 29 / 79 )}^{k} .$$

Since 0.3671≈29/79<½, the probability of error is smaller than ½^{k}, after the δk=29 k translations are removed from S₁, there remains at least one translation that is correct, has the correct representations for the inputs values x₁, . . . ,xₙ, and was not used in any of the verifications. In one embodiment, since the revealed val(X_{L}^{(j)}) is the same for all the translations TR^{(j)} not used in any of the verifications, that value is the correct output value x_{L} of the SLC (1). Accordingly, the total probability of error is less than 3/2^{k}.

The Verification of Correctness is Secrecy Preserving

In one example, the proof of the secrecy preserving property is conducted in the random oracle model for the commitment function COM. COM:{0,1}^{k+128}→{0,1}^{k+128} is a random permutation. Whenever the EP or the Verifier has an argument value wε {0,1}^{k+128}, he can call on COM and get the value v=COM(w). To commit to a number xε Fₚ, the committer randomly chooses a help value rε {0,1}^{k} and obtains v=COM(r ∥ x). To de-commit v, the committer reveals r and x, and then the commitment to x is verified by calling the function COM. (See Damgaard, Pedersen, and Pfitzmann, “Statistical Secrecy and Multibit Commitments,” IEEE Transactions on Information Theory, vol. 44, no. 3, pp. 1143-1151, 1998 for a related but more sophisticated approach to commitments.)

The EP prepares the K translations of the SLC (1) as detailed above, and posts commitments to all the coordinates of all the pairs appearing in the translations, keeping to himself the help values r₁,r₂, . . . employed in the commitments.

In one aspect, a main idea of the proof is that in the verification process all that is being revealed are randomly independent elements of Fₚ, and relations of the form u₁+u₂+ . . . +uₛ=v or u₁×u₂=v, for randomly independent u₁,u₂, . . . in Fₚ. According to some embodiments, the properties of the commitment scheme ensure that nothing can be learned about a value uε Fₚ from a commitment to it.

In one example, to simplify the proof of the secrecy preserving nature of the verification process, assume that every party Pⱼ is proper and submits to the EP K randomly independent representations Xⱼ⁽¹⁾, . . . ,Xⱼ^{(K)} of his input value xⱼ. One should appreciated that allowing improper parties does not change the essence of the proof and the result.

Considering the verifications of Aspects 0-8 of the translations TR^{(j)}, 1≦j≦K, posted by the EP via commitments:

Aspect 0 relates to the pair-wise value-consistency of the arrays of inputs. In the basic step, the Verifier requests of the EP to reveal for two representations Xₘ⁽ⁱ⁾ and Xₘ^{(j)} of input xₘ submitted by party Pₘ, the values of, say, their first coordinates uₘ⁽ⁱ⁾ and uₘ^{(j)}. The Verifier then verifies that uₘ⁽ⁱ⁾−uₘ^{(j)} equals d₁, a value that was posted by EP. Since, according to some embodiments of the protocol, party Pₘ used random representations of xₘ all these first coordinates are independent random elements of Fₚ.

According to one embodiment, Translation TR^{(j)} contains representations Z₁^{(j)}, . . . ,Zₛ^{(j)} of 0; new representations Y₁^{(j)}, . . . ,Yₜ^{(j)}, . . . so that every xₘ in the SLC has as many new representations as the number of times it is involved in computations of the SLC; and representations NXₘ^{(j)} for every xₘ resulting from a computation in the SLC. Aspects 1, 2 and 3 respectively deal with the correctness of these Z, Y and NX representations.

The first lemma addresses the Z's with respect to some embodiment:
Lemma 10 In the set of translations {TR⁽¹⁾, . . . ,TR^{(K)}}, any collection of coordinates of representations of 0 which does not contain both coordinates of the same representation, consists of independently randomly chosen numbers from Fₚ.
Proof: This follows from the construction of the random representations of 0, discussed above.

The next lemma addresses the Y's and the NX's with respect to some embodiments:
Lemma 11 In the set of translations {TR⁽¹⁾, . . . ,TR^{(K)}}, any collection of coordinates of the representations Yᵢ^{(j)} and NXₘ^{(j)} which does not contain both coordinates of the same representation, consists of independently randomly chosen numbers from Fₚ.
Proof: Every such representation Yᵢ^{(j)} or NXₘ^{(j)} is the result of an operation of the form Yᵢ^{(j)}=X+Z or NXₘ^{(j)}=X+Z, where X is some previous pair in TR^{(j)} and Z is a random representation of 0 from TR^{(j)}, and where Z is used only once. The result now follows from the previous Lemma.

In one example, checking Aspect 1 of a translation involves the revelation by the EP of all coordinates of all representations of 0 in a number of translations. According to one embodiment, by construction of the translations, all representations (z,−z) of 0 were constructed by the EP using independently random choices of z, and no other value in those translations is revealed. Thus the revealed values are randomly independent and randomly independent from any other values revealed in the total verification.

In a translation TR of one embodiment the symbols X₁,X₂, . . . ,Xₘ, . . . ,X_{L} denote representations of the values x₁,x₂, . . . ,xₘ, . . . ,x_{L} of the SLC (1).
Lemma 12 In some embodiments, let U={X₍ₙ₊₁₎^{(j)}, . . . ,X_{L}^{(j)}|1≦j≦K} be the set of all representations of non-input values xₙ₊₁, . . . ,x_{L} in all translations TR^{(j)}, 1≦j≦K, of the SLC (1). Then any collection of coordinates of the representations in U which does not contain both coordinates of the same representation consists of independently randomly chosen numbers from Fₚ.
Proof: By the construction of a pair Xₘ^{(j)} in the translation TR^{(j)}, if xₘ=xᵢ+xⱼ in the SLC (1) then Xₘ^{(j)}=Y′+Y″ where Y′,Y″ are new random representations of xᵢ and xⱼ (see (3)). Thus the claim follows from Lemma 11.If xₘ=xᵢ×xⱼ then Xₘ^{(j)} is constructed from new random representations Y′,Y″ of xᵢ and xⱼ according to (6a)-(6e). The use of random representations of 0 in (6a)-(6e) establishes the claim.
Remark. Under the assumption that all parties P₁, . . . ,Pₙ are proper, Lemma 12 extends to the coordinates of the representations X₁^{(j)}, . . . ,X_{L}^{(j)} of all the numbers x₁, . . . ,x_{L} of the SLC (1).
Lemma 13 In some embodiments, verifying Aspect 2 of a translation TR involves checking equations of the form u+z=v where all the numbers u, z that are revealed (de-committed) are randomly independent elements in Fₚ.
Proof: The equations to be simultaneously verified are of the form Xⱼ+Zₑ₍ⱼ₎=NXⱼ where Zₑ₍ⱼ₎ is a new random representation of 0 for every equation. The verification is done by checking equations of the form u+z=v where in each case u, z, v are simultaneously the first or simultaneously the second coordinates of Xⱼ, Zₑ₍ⱼ₎ and NXⱼ. The random independence claim for the u, v follows from Lemma 12.
Lemma 14 In some embodiments, verifying Aspect 3 of a translation TR involves checking equations of the form u+z=v where all the numbers u, z revealed (de-committed) are randomly independent elements in Fₚ.
Proof: Verifying Aspect 3 involves verifying all equations of the form Y=Xⱼ+Z for the input value representations and Y=NXⱼ+Z for representations of intermediate results of the SLC, where in each case Z is a different representation of 0 from the list Z₁, . . . ,Zₛ of representations of 0 in TR. The result follows from Lemma 12, the construction of Z₁, . . . ,Zₛ, and the fact that verifying such an addition of representations (pairs) involves revelation of either all first coordinates or all second coordinates of the pairs in question.
Lemma 15 In some embodiments, verifying Aspect 4 of a translation TR involves checking equations of the form u₁+u₂=v and w₁+ . . . +w₄=w where all the numbers u₁, u₂, w₁, . . . ,w₄ revealed (de-committed) are randomly independent elements in Fₚ.
Proof: This follows from the definition of Aspect 4 in a manner similar to the proof of Lemma 14.
Lemma 16 In some embodiments, verifying Aspect 6 of a translation TR involves checking equations of the form u₁×v₂+z=w₁ where the numbers u₁, v₂, z revealed (de-committed) are randomly independent elements in Fₚ.
Proof: Verifying Aspect 6 involves checking in TR simultaneously all equations of the form (6b) arising in translations of multiplications xₘ=xᵢ×xⱼ of the SLC (1). Such a translation employs unique random representations Y′=(u₁,v₁) and Y″=(u₂,v₂) of xᵢ and xⱼ and a representation Z=(z,−z) of 0. To be verified simultaneously are all additions Xₘ^{†′}=(u₁×v₂,0)+Z in TR. If the challenge is c and Xₘ^{†′}=(w₁,w₂) then all the u₁, v₂, z and w₁ are revealed by the EP and all equations u₁×v₂+z=w₁ are checked by the Verifier. By Lemma 11, all the revealed u₁, v₂, z are randomly independent elements of Fₚ.

The proof for the secrecy preserving nature of Aspects 5 and 7-8 is similar.
Theorem 17 In some embodiments, the verification of correctness of the K translations TR^{(j)}, 1≦j≦K, of the SLC (1) is secrecy preserving.
Proof: The verification process involves randomly choosing 2αk=11 k translations for verifying Aspect 0 (the value-consistency of the input arrays) and randomly choosing δk=29 k arrays for verifying Aspects 1-8.

In one example, let C₁, . . . ,C_{K} be a collection of coordinates of representations of values from the translations TR^{(j)},1≦j≦K, such that no Cⱼ contains both coordinates of the same representation (pair). By the construction of the K translations, the values in any Cⱼ are randomly independent from the values in all other Cᵢ's.

According to one embodiment, any one of the (α+δ)k=40 k translations used in the verification is involved in the verification of just one of the Aspects 0-8, i.e. is used only once.

According to some embodiments, from the detailed analysis given above for the verification of Aspect 0 and in Lemmas 10-16, all the coordinate values from presentations of a translation TR^{(j)} revealed during the verification satisfy the condition on Cⱼ. Furthermore, they are mutually randomly independent values in Fₚ, except for relations such as u+z=v, u₁×v₂+z=w₁, etc. dictated by the structure of the translation process. By the above observation on C₁, . . . ,C_{K}, the verification of Aspects 0-8 only reveals some randomly independent elements of Fₚ and some sums and products of such elements (which could be computed by the Verifier on his own).

Finally, in TR^{(j)} not used in the verification of Aspects 0-8, the Verifier asks the EP to de-commit both coordinates of X_{L}^{(j)}=(u_{L}^{(j)},v_{L}^{(j)}). The Verifier checks that all the revealed pairs have the same sum u_{L}^{(j)}+v_{L}^{(j)}=x_{L}, where x_{L} is by definition the result of the SLC (1). The revealed coordinates of all the X_{L}^{(j)} involved in this final step are again randomly independent values in Fₚ, subject to the condition that the two coordinates of each pair all sum to the same value.

In the random oracle model for the COM function, all values x of coordinates of pairs in all translations, the values v=COM(r ∥ x) are randomly independent elements of {0,1}^{k+128}.

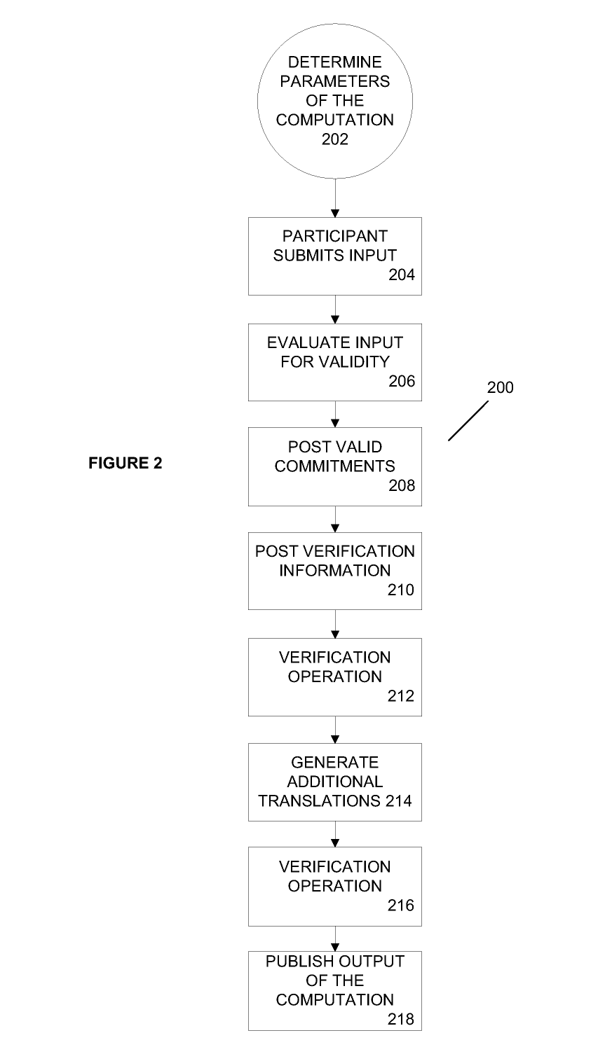

With respect to FIG. 2, shown is an example of a process, 200, for performing a verifiably correct secure computation. At step 202, the parameters for the computation are established. In one embodiment, the parameters for the computation describe the function used to derive the output from received inputs. In one example, the function is a straight line computation (SLC). One should understand that the invention is not limited to a straight line computation and other types of computational processes may be employed to generate a verifiably correct output while preserving secrecy of the received inputs and/or secrecy of intermediate steps in the calculation.

In another embodiment, the parameters also include commitments to random streams of data used in the computation. Establishing commitments to the random data used in the calculation reduces the ability of an operator to compromise secrecy through a covert communication channel. In yet another embodiment, the parameters also include a commitment operation, that operates to conceal the committed information and operates to bind the committed information. As is known in the art, concealing commitments refer to the property of the commitment that it is computationally intractable to generate the underlying committed value from the commitment itself. Also known in the art, binding refers to the property that it is computationally intractable to generate another underlying value that will match the commitment, thus any attempt to alter a value will be detected with a high degree of certainty.

In some embodiments, parameters include a translation operation, that provides for translating values into a randomized representation of the value. In another embodiment, the parameters establish boundaries for the translation operation. In one example, the translation function translates a value into a randomized pair of values that determine the original value upon application of a function. An example of the function, includes addition of the pair of values to determine the value. Another embodiment employ a combination of addition operations, subtraction operations, multiplication operations, still other embodiments use subsets of the preceding operations.

In another embodiment, the parameters include a digital signature operation used in computation. In other embodiments, further parameters are established that limit inputs from participants to specific ranges, and include requirements for establishing a valid input.

At step 204, a participant submits an input to be used in the computation. In one embodiment, the input is submitted to an Evaluator/Prover. In another embodiment, the submission is delivered to a receiving entity, which in turn delivers all received submissions to an operator when the period for providing submissions expires. Such a delay increases the security of some embodiments by preventing the operator from learning any information that can be beneficially leaked before the utility in leaking the information expires. For example, in the context of an auction, leaking bid information after the close of bidding, reduces the utility of such a leak.

At step 204, a participant prepares an input by generating an input value, and a commitment to the input value and submits the same. In another embodiment, the participant also prepares a translation of the input into a randomized representation of the input, prepares commitments to the randomized representations and submits an input, a commitment to the input, a randomized representation of the input, and commitments to the randomized representation. In one example of an implementation, the parameters for the computation identify a number of translation required for each input. In such an implementation, a participant prepares the number of translations indicated, commitments to each, and submits the plurality of translations, commitments to the translations, the input, and a commitment to the input. In another embodiment, submitted inputs are digitally signed before submission.

At step 206, an operator verifies that the submitted inputs are valid. The verification by the operation may include verifying digital signatures, all commitments submitted, and all translations. At step 208, the operation posts valid commitments to the randomized representation. According to one embodiment, participants who wish may verify that the posted commitments were made by the proper parties using the digital signatures. At step 210, the operator provides verification information that permits a verifier to determine the translated values were generated properly. In one example, the operator posts the differences between two sets of components that are the randomized representation of an input. In the example where a pair of values is the randomized representation, the posted differences are generated from the difference between the first element of the two sets, and the difference between the second element of the two sets. At step 212, a verifier requests revelation of a portion of the randomized representation. In one example, the revelation request is for one half of each pair of values. The verifier uses the verification information and the revealed portion to verify, with a certain degree of confidence that computation is correct, without being able to learn the actual input representation by the randomized representation.

At step 214, the operator generates additional translations for use in the computation. In one example, the operator prepares a plurality of randomized representations of zero, and uses the randomized representations of zero in creating new translations from the submitted inputs. In another example, translations are also prepared to represent the value of operations performed on the submitted inputs. In one embodiment, a sum of values is represented by a randomized representation of that sum. In another embodiment, a multiplication of values is also represented by a randomized representation of that multiplication. Other examples include the use of translations in inequality operations, equality operations, subtraction operations, exponentiation operations, addition operations, and multiplication operations. Some embodiments employ subsets of the previous operations, and thus only need translations sufficient for those operations.

At step 216, a verifier request the operator to reveal portions of the additional translations. The revealed portions are used to verify, to a certain degree of confidence, the translations used in the computation. In one example, the verifier request the operator reveal all components of the randomized representations of zero. Each representation of zero is verified. In another example, the verifier also request that the operator reveal a portion of the translation of operation results. One example includes, revealing a portion of a randomized representation, where the randomized representation represents the value of an addition operation on a randomized representation of zero and a randomized representation of an input. Another example includes a request to reveal a portion of a multiplication operation, an inequality operation, an equality operation, and an exponentiation operation. Some examples used subsets of the previous operations, thus requests are limited to the performed operations in those examples. In one example, the verifier also requests the operator reveal all the components of the randomized representation representing the output of the computation. The verifier verifies that the values for all the representation of the computation are consistent.

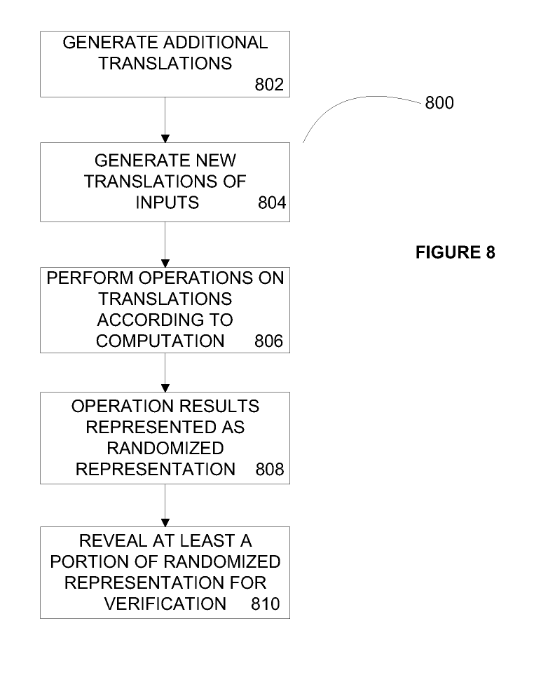

Steps 214-216 may include additional acts as in, for example, one example process 800, FIG. 8. Process 800, includes generation of additional translations at step 802. In one example, the additional translations, comprise randomized representations of zero. In another example, the randomized representations of zero, comprise a pair of values the determine zero through a function.

The additional translations are incorporated into new translations of inputs according to the predetermined calculation at 804. Operations, including at least one of addition, multiplication, exponentiation, and establishing inequality between values, are then performed according to the predetermined calculation, at 806. At 808, the results of the operations are also represented as randomized representation of the results. At step 810, a portion of the randomized representations are revealed enabling verification of the calculation while preserving secrecy of the inputs to the calculation. In some embodiments, process 800, is implemented as part of another process for verifiably determining an output resulting from inputs according to a predetermined calculation while preserving secrecy of the inputs and intermediate calculations, such for example process 200. In one example, process 800 may be implemented as part of steps 214-216.

With further reference to FIG. 2, at step 218, the output of the computation is published. One should appreciate that the ordering of the preceding steps is not meant to be limiting. In one particular example, the verification steps may be performed as one step at the conclusion of the computation, and in one example are so performed. Additionally, each step of the computation may involve a separate verification step.

An Application to Auctions

Below examples of applications to secure auctions are described. After touching on security and privacy concerns particular to cryptographic auctions, a basic approach for straight-line computations described above is augmented to handle comparison steps x≦y and summarize a cryptographic auction protocol using our methods.

Auction Considerations

Cryptographic auctions are an ideal example to provide real-world context. Auction theory has developed complex pricing algorithms for “strategy proof’” auctions (that is, a bidder's best strategy is to bid her true utility), but information about one bid being revealed to another bidder could change the outcome of the auction. Moreover, in many applications, such as wireless spectrum auctions conducted by the FCC, bidders do not want their bids to be revealed to other bidders (because it constitutes proprietary business information) yet the auctions must be transparent to comply with Federal regulations.

In one embodiment, the auction protocol has the following characteristics: 1) it must be practically efficient enough to compute functions of the bids; 2) bids must be secret, in that no bidder can learn anything about any other bid before the deadline to submit a bid; and 3) the results must be able to be proven correct without revealing the original bids. Some embodiments support all of these requirements: 1) efficiency demonstrated in empirical tests; 2) other known cryptography, such as cryptographic commitments or time-lapse cryptography (discussed in Rabin and Thorpe's “Time-Lapse Cryptography,” Technical Report TR-22-06, Harvard University School of Engineering & Applied Sciences, 2006), can enforce bid secrecy until the auction is closed; and 3) the embodiments of the protocols presented in this work issues a correctness proof that reveals nothing about the bids (clearly, it reveals nothing that is not implied by the results).

In one example, the extent of trust placed in an auctioneer is that he will not reveal any information about the bids except for the outcome of the auction and what is implied by announcement of the outcome. For example, in a Vickrey auction where the item goes to the highest bidder at the price bid by the second highest bidder, the announcement will reveal the identity of the winner. Whether the winner's payment will be revealed depends on the announced rules of the auction, but if so, then the second highest bidder's bid is also revealed. When the rules demand it, embodiments of the protocols can enforce the secrecy of auction payments, so that each bidder receives a private proof of the correctness of any payment without learning additional information.

According to one aspect, the rationale for this partial trust model is that illegally and selectively leaking out bid values before the closing of the auction, or announcing a false auction result, can benefit particular bidders, the auctioneer, and/or the seller. Some embodiments of the protocols completely prevent such malfeasance. On the other hand, leaking out bid values after the end of an auction only helps parties who receive such information in strategizing for future similar auctions. The value of this information advantage is, however, relatively limited. Consequently the auctioneer, who has his business reputation to guard, has a substantial incentive not to leak out information after the conclusion of auctions. There are other approaches to building secure systems in which such post-auction leaks are prevented.

Examples of an Auction Protocol

In “Practical secrecy-preserving, verifiably correction and trustworthy auctions” (for a more detailed review, see the literature quoted there), a known protocol is proposed for conducting secure and secrecy preserving auctions. Bidders choose their bids, encrypt them using a homomorphic encryption scheme, and send commitments to these encrypted bids to an auctioneer; they do this by posting them on a public bulletin board. After all bids are in, the auctioneer announces that the auction has closed, and the bidders submit their encrypted bids to the bulletin board. These can be easily verified against the previously published commitments. The auctioneer then privately opens the encrypted bids and computes, according to the posted auction rules, who the winner(s) is (are) and their payments. He then posts a publicly verifiable Zero Knowledge Proof for the correctness of the results, based on the encrypted bids published on the bulletin board.

This proof can be done in a manner revealing the identities of the winners and their payments or, if so desired, concealing that information. But in any case, the bids of all other bidders except for those of the winners remain secret. The only trust assumption made is that the auctioneer, who knows the bid values, will not reveal that information after the auction. The protocol described employs Paillier's homomorphic encryption scheme discussed in “Public-key cryptosystems based on composite degree residuosity classes,” Advances in Cryptology (vol. 1592) of Lecture Notes in Computer Science, pgs 107-122, Springer-Verlag, 1999, for bid secrecy and proofs of correctness; his scheme allows these proofs to be verified by using only the encrypted bids.

It was shown “Practical secrecy-preserving, verifiably correction and trustworthy auctions” that the protocols given there are practical and that currently available computing power suffices to implement auctions with thousands of bidders within reasonably practical time (on the order of one day for a single computer). Still, that solution employs special encryption functions and basic Paillier encryption is a relatively heavy computation.

Theoretical framework for secrecy-preserving, provably correct computation described above is extendible for conducting a sealed-bid auction; to complete the necessary set of primitives explained is how zero-knowledge comparisons of two values can be handled in our protocol. (This is a general extension of the SLC framework independent of the specific application to auctions.) Below are some simple optimizations of the approach described in the previous sections that give an improvement in efficiency. Also described is an example of how some embodiment can be used to prove correctness of a Vickrey auction result.

Translation of Inequalities 0≦x≦B and x≦y.

In one example, let 0<b<p be values that satisfy 32b²<p.

First suppose that the Evaluator-Prover has a value 0≦x≦b, it is explained how the EP can prove that −b≦x≦2b. Next, using this first step, if the EP has 0≦x≦b² it is explained how he can give a secrecy preserving proof that 0≦x≦16b². Finally it is described how this enables him to prove that 0≦x≦y≦16b² for two values x, y that satisfy 0≦x<y≦b².

In one example, EP has a value 0≦x≦b, and wants to prove that −b≦x≦2b, i.e. that either 0≦x≦2b or p−b≦x<p. The following construction includes an adaptation of a known method of Brickell et al. described in “Gradual and verifiable release of a secret,” in Proceedings of CRYPTO'87, vol. LNCS293, pgs 156-166, 1988, to the present context.

In one embodiment, the EP selects a random value 0≦w₀≦b and sets w₁=w₀−b. He sets

$$r = \{ \begin{matrix}{w}_{0} + x & if {w}_{0} + x \leq b ; \\ {w}_{1} + x & if b < {w}_{0} + x .\end{matrix} \qquad ( 10 )$$

It can be seen that this r is uniformly distributed in the interval [0,b]. If a Verifier checks that the pair (w₀,w₁) satisfies the condition w₁+b=w₀ and that for some ζε {0,1}, it is the case that 0≦w_{ζ}+x≦b, then the Verifier may infer that −b≦x≦2b is true.

In one example, to enable the verification in a secrecy preserving manner, the EP includes in the translations TR a representation X for x; two representations W′, W″, for the values w₀ and w₁; and a representation R for the value r defined by (10). In one embodiment, the two representations W′, W″ in the translations occur consecutively (these can follow the Z's in the overall translation of the entire computation, see (8), but in an order that is randomly chosen by the EP. That is, when the translations are being constructed, the EP randomly decides whether the first representation W′ represents w₀ or w₁ (and then the second representation represents the other value).

According to one embodiment, the translation of the statement −b≦x≦2b requires commitments to eight values in Fₚ (the two components of each of the four pairs X, W′, W″, and R). For the actual verification, according to one example three of the previously described Aspects (Aspects 1, 2 and 3) are modified as follows.

In Aspect 1, a translation TR is correct with respect to representations of the w's if for each couple of pairs W′,W″ arising in a comparison step as described above, val(W′)=val(W″)−b or val(W″)=val(W′)−b. To verify that TR is correct in Aspect 3, in addition to checking all zeros as described earlier, the Verifier also requests of EP to reveal (de-commit) all coordinates of all pairs W′, W″ and checks that for the values corresponding to each pair, it is indeed the case that one of the two equalities holds.

In Aspect 3, translation TR is correct with respect to representations of the r's if for each comparison step as described above, it is indeed the case that for some W*ε {W′,W″} val(R)=val(W*)+val(X). To verify that TR is correct in Aspect 2, in addition to checking all computations of Y₁, . . . as described earlier by choosing a random cε {1,2}, the following moreover takes place. The EP selects the element of {W′,W″} that corresponds to the correct value of ζ such that r=w_{ζ}+x; the element he selects are referred to as W*. In one example, if c=1 then EP reveals (de-commits) the first coordinate in all computations of R=W*+X. The Verifier checks that the first coordinates of W* and X sum up to the first coordinate of R. He rejects if even one of these checks fails. The case c=2 is handled similarly.

In Aspect 2, a translation TR is correct with respect to the range of the r's if the new representation R satisfies 0≦val(R)≦b. In one embodiment, to verify correctness in Aspect 2, in addition to checking all computations of NXⱼ as described earlier, the EP de-commits both coordinates in all computations of R, the new representation of r. The Verifier sums the two coordinates to obtain val(R) and checks that the two coordinates add up to a value that lies in the interval [0,b]. In some embodiments, the EP ensures that this value val(R) is r, which is a “fresh” random value from [0,b] independent of everything else seen by the Verifier; thus secrecy is preserved.)

In an example of a verifiable computation applied to an auction, the verification of the modified aspects are performed in process 100, FIG. 1, as part of steps 122-124.

Suppose, in one example, that 0≦x≦b². The EP wants to enable a secrecy preserving proof that 0≦x≦16b². One embodiment describes an approach by which he can do this.

By Lagrange's theorem, there exist nonnegative integers x₁,x₂,x₃,x₄ such that

x=x₁²+x₂²+x₃²+x₄² with 0≦x₁,x₂,x₃,x₄≦b. (11)

There is an efficient randomized algorithm known that, given x as input, finds a sum of four squares representation (11) for x (Rabin and Shallit, “Randomized algorithms in number theory,” Comm in Pure and Applied Mathematics 39 (1986), 239-256). Using this algorithm, the EP computes the Lagrange representation (11) and for each of the values x₁,x₂,x₃,x₄, prepares a translation enabling a proof that −b≦xⱼ≦2b, as described above. He creates representations X for x and X₁, . . . ,X₄ for x₁, x₂, x₃, x₄. He prepares translations for the computations xⱼ²=xⱼ×xⱼ for 1≦j≦4, and for the equality (11). In one example, if a Verifier checks the above relations using the representations, then the Verifier knows that 0≦x≦4·4b²=16b².

Also suppose in another example, that 0≦x≦y≦b². The EP wants to give a secrecy preserving proof that 0≦x≦y≦16b². He does this simply by giving a secrecy preserving proof that 0≦x≦16b² (which he can do since 0≦x≦b²), a secrecy preserving proof that 0≦y≦16b² (which he can do since 0≦y≦b²), and a secrecy preserving proof that 0≦y−x≦16b² (which he can do since 0≦y−x≦b²). It is clear that these bounds establish that 0≦x≦y≦16b², according to one embodiment.

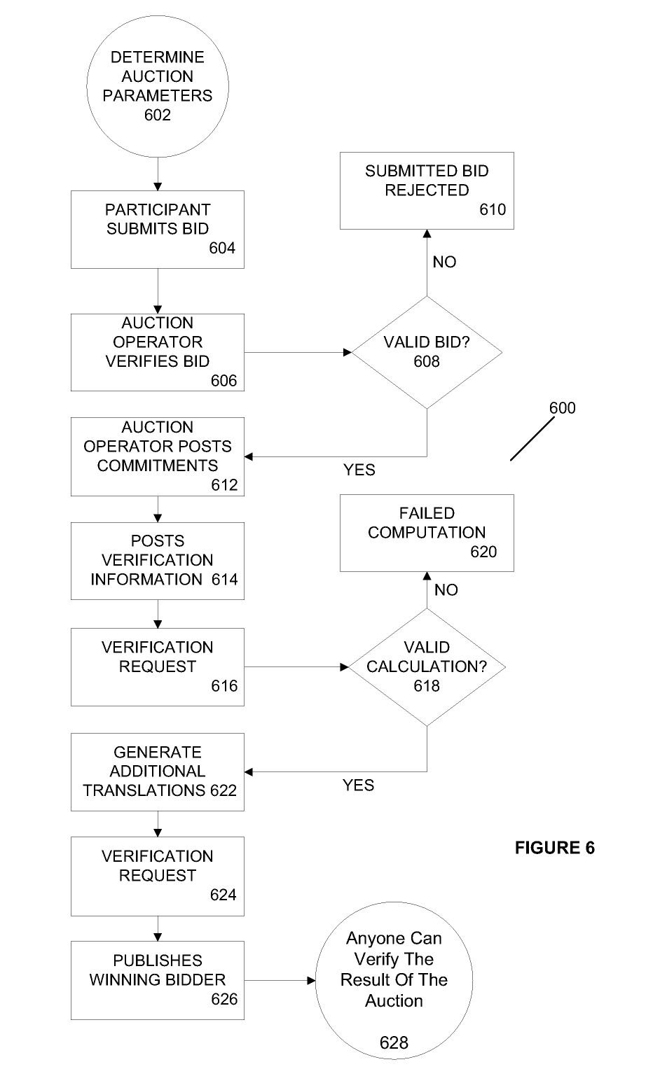

With respect to FIG. 6, shown is an example of a process 600, for conducting a verifiable secrecy preserving auction according to various aspects of the invention. At step 602, the auction parameters are determined. According to one embodiment the parameters of the auction include the calculation used to derive the outputs from submitted inputs, constraints placed on submitted bids. In another embodiment, the parameters also include a commitment operation, a digital signature operation, used in submission of bids. In other embodiments, the commitment operation is used whenever data is posted during the execution of the calculations. In one example, the auction parameters define a number of translations that must be submitted with a bid to meet requirements.

At step 604, participants submit bids according to the parameters of the auction. In one example, a proper submission includes the submitted bid, a commitment to the bid, translations of the bid into randomized representations, and commitments to the randomized representations. In another example, each portion of the submission is also signed using a digital signature. At step 606, the auction operator verifies the submissions for each bidder. In one example the auction operator checks the bid, the commitment to the bid, the randomized representation of the bid, the commitments to the randomized representation, as well as the digital signatures on the same.

At 608 the Auction Operator determines if the submission is a valid bid. At 608 NO, the Auction Operator determined the bid is not valid and rejects the submitted bid at 610. At 608 YES, the Auction Operator determines the bid was submitted properly and the Auction Operator posts the commitments to the randomized representations for review at 612. At step 614, the Auction Operator posts verification information that permits verification by others (other bidders, observers, etc.) that the submitted and posted commitments are valid. In one example, the verification information is a difference generated from the values of pairs of randomized representations.

At step 616, a verifying entity (participant, automated process, etc.) requests revelation of portions of the randomized representations held by the Auction Operator. The Auction Operator reveals the requested portions, which permits the verifying entity to determine the correctness of the posted commitments. The verifying entity determines if the posted commitments represent valid calculations, at 618 NO, it is determined that improper submission were posted, and the computation fails at 620. At 618 YES, it is determined that the calculation is valid, and the Auction Operator proceeds with the calculation used to derive the outputs from submitted inputs. At 622, the Auction Operator generates additional translations for use in the calculation, so that operations in the calculation can be performed and verified in a secrecy preserving manner. The additional translations include, generation of translation of zero, that are further incorporated into further translations of values, as is discussed above. The Auction Operator commits to the additional translations, and in response to a verification request at step 624, reveals at least a portion of the randomized representations generated as a result of the translations. In one example, an entire translation is revealed, according to the discussion above with respect to consistent representations of zero.

If the verification request fails, the calculation is invalid. If the verification validates the calculation of the outputs, and the outputs themselves, a winning bidder is published at step 626. With the posted information, commitments, revealed components, etc. anyone can verify that the result of the auction is proper at 628.

In the next section, described is an optimization that reduces the number of commitments required for a naive instantiation of some of the teachings of the above approaches.

An Optimization: More Efficient Sum of Four Squares and Additions.

According to one aspect, an optimization that can be performed, in one example, that reduces the number of commitments required to perform the sums of four squares in (11) and certain other sequences of operations.

According to one embodiment, the optimization is to perform a sequence of additions “in one step”, similar to our implementation of a multiplication step. Recall that a multiplication step xₘ=xᵢ×xⱼ is implemented, in some embodiments, as follows: after constructing representations Xₘ^{†}, Xₘ^{†′}, Xₘ^{†″} and Xₘ^{†′″} , the EP constructs the final Xₘ as Xₘ^{†}+Xₘ^{†′}+Xₘ^{†″}+Xₘ^{†′″} in one step, rather than performing three pairwise additions (which would necessitate representations for the intermediate sums, new representations for their subsequent use in the overall sum, etc.). (See for example, the verification of Aspect 3 described above).

In one example, a similar approach can be taken when constructing the sum of four squares x₁²+x₂²+x₃²+x₄². Since the intermediate pairwise sums are not used, all three additions are performed at once and save on the intermediate representations that would otherwise be constructed. One should appreciate that a similar approach can be taken for any sequence of consecutive additions that occurs anywhere in the SLC.

Proving Correctness in Examples of a Vickrey Auction.

According to one embodiment, in a Vickrey auction participants P₁, . . . ,Pₙ submit bids x₁, . . . ,xₙ. The winner is the highest bidder and the price he pays is the second highest price. In this setting the Auctioneer acts as the EP. Without loss of generality, and excluding the case of equal winning bids for convenience, assume that

p/32>b²>x₁>x₂;x₂≧x₃, . . . ,x₂≧xₙ. (12)

Thus the EP has to prepare translations enabling a secrecy preserving proof of the inequalities (12). In one example, the EP first prepares translations for proving that 0≦xᵢ≦16b² for each i=1, . . . ,n. He then proves that x₂<x₁ (by proving that 0<x₁−x₂≦16b² ), that x₃≦x₂, that x₄≦x₂, and so on as described in above. Thus, in this example, there are a total of 2 n proofs that various values v satisfy 0≦v≦16b². One should appreciate that the modifications discussed above with respect to an auction setting are not limited to an auction setting and may be employed in other secrecy preserving computation settings.

Efficiency of the Protocol Embodiments

A careful analysis of the translation of the n-participant Vickrey auction computation performed in some embodiments, reveals that 101 n pairs are constructed within each translation. As discussed above with respect to some embodiments, the secrecy preserving proof involves 90 k different translations, and thus all in all, the posted proof consists of 90 k·101 n·2 commitments to values in Fₚ. (The final factor of two is because there is one commitment for each of the two elements of each pair.)

For an example with a security parameter k=40 and number of bids n=100, this means around 72.7 million commitments. For pragmatic reasons, to commit COM(x) the SHA-1 cryptographic hash function is employed on x with a random 128-bit help value r: COM(x)=SHA1(x ∥ r). One should appreciate that other commitment function may be likewise employed. The more sophisticated theoretical approach of Damgaard Pedersen, and Pfitzmann, “Statistical Secrecy and Multibit Commitments,” IEEE Transactions on Information Theory, vol. 44, no. 3, pp. 1143-1151, 1998 could also be used, for example, without a significant effect on efficiency. This yields 160 bits of output for each commitment, for a total proof size of approximately 1.45 GB with the above parameters. While constructing the proof requires committing to all values, and the entire proof is downloaded by the verifier, examination of the verification process described above shows that according to some embodiments no more than 5% of the committed values need to be verified by decommitment at the end of the protocol. (To check a commitment, the verifier requests indices of the elements to decommit; the EP sends the random seeds and actual elements; then the verifier rehashes their concatenation and checks for equality.)

Empirical experiments comparing the performance of some embodiments on sealed-bid auctions to that of a previously published auction protocol based on homomorphic encryption, discussed in “Practical secrecy-preserving, verifiably correction and trustworthy auctions,” have been conducted. The results bear out the claim that the proposed solution is significantly faster than solutions based on homomorphic cryptography. There is, however, an important time/space tradeoff: the correctness proofs in some embodiments of the solution are very large, because of the large number of commitments necessary to guarantee correctness with high probability. The analysis therefore included not only calculations of the cost of computing all of the cryptographic hashes (by far the dominant computation) but also estimated the transfer time for the verifier to download the very large proof of correctness. Although, the running time of the other operations necessary were tested to construct and verify a proof for a cryptographic auction, these take at most a few seconds and they were omitted from the following discussion. These operations include generating random data, decomposing the sum-of-four-squares representations, and multiplication and addition of values modulo p.

To yield fair comparisons, tests were executed using the same 2.8 GHz 32-bit Pentium 4 processor used on the homomorphic cryptographic auction protocol in “Practical secrecy-preserving, verifiably correction and trustworthy auctions” with which embodiments of the new approach were compared; obviously use of faster 64-bit processors would significantly improve the efficiency in all cases. It is estimated that the timing presented here would be improved by a factor of 2 or 3 if run on 2007 state-of-the-art hardware. Assume was a 2.5 megabyte per second transfer rate for the proof download. Times given in Table 1 reflect a security parameter k=40 for one example of the proposed protocol and a 2048-bit public Paillier key in the homomorphic cryptographic setting.

TABLE 1
Single-Item Auctions of 100 Bids

| | | |
|---|---|---|
| Operation | Proposed | Homomorphic |

| | | | | |
|---|---|---|---|---|
| Preparing the proof | 4.11 | minutes | 804 | minutes |
| Downloading the proof | 9.67 | minutes | <1 | minute |
| Verifying the proof | <1 | minute | 162 | minutes |

A Secure Co-Processor Embodiment

In one embodiment, instead of the EP entity, which may be a person or some organizational entity, a Secure Processor Evaluator-Prover (SPEP) implements a verifiable secrecy preserving computation. In one example, the computation is a straight line computation.

One embodiment reduces opportunities for covert channels by introducing an additional step before any inputs are provided to the SPEP to prevent the SPEP from introducing information into the random help values. In this embodiment, the SPEP creates a list of sequentially numbered random values to be used later as help values for the COM operation and as values in Fₚ to be used in the translations. Again, this list is created before the SPEP receives any inputs to any computation.

The SPEP then creates a corresponding list of identically numbered binding, hiding cryptographic commitments to these random help values and digital signatures on each of these commitments. The SPEP publishes this list of sequentially and identically numbered commitments and signatures to any interested parties who may wish to verify the correctness of the outcome of the computation, in one example, via the bulletin board described elsewhere herein.

In some related embodiments, the SPEP must use the random values in the list of sequentially numbered random values, in the order of their numbering according to a publicly known protocol, as help values in the COM operations and as values in Fₚ when preparing the translations. Because these actual random values have only been committed to, not revealed, the SPEP has revealed no information by using these predetermined random help values. In some related embodiments, whenever the SPEP posts a random help value from this list to prove a translation correct or unlock a commitment (made by a COM operation) as part of the proof of correctness, the SPEP also unlocks the corresponding commitment from the identically numbered list of commitments to the random help values, which proves that the random help value employed in creating a particular translation or commitment was the random value designated by the SPEP for that purpose before the SPEP had knowledge of any inputs. This prevents the SPEP from manipulating any random help values to covertly disclose any information learned from the inputs.

In another embodiment of the secure processor model, the secure processor is programmed to perform the functions of the Evaluator-Prover, as previously described, for accepting input values x₁, . . . ,xₙ, executing for example a SLC (1) on these values, preparing a proof of the correctness of the computation and outputting (posting) that proof.

In some embodiments, the secure processor is trusted to only post the proof and not any other information. However, even in such embodiments the SPEP is not trusted to correctly execute the calculation and a verifiable proof of correctness is needed.

It is realized that a secure processor may leak out information in a number of ways. In one example, the format of the posted proof may be used to leak out information on input and intermediate values of the computation through use of spaces, fonts used, format, etc. (J. McHugh, “Covert Channel Analysis,” Ch. 8, Handbook for Computer Security Certification of Trusted Systems, NRL Technical Memorandum discusses background on covert channels.) Also in some embodiments, the EP requires a considerable stream of random bits for implementing the translations TR^{(j)}, 1≦j≦K. A secure processor can leak out information on input and other values through appropriate choices of random values that will be revealed in the verification process.

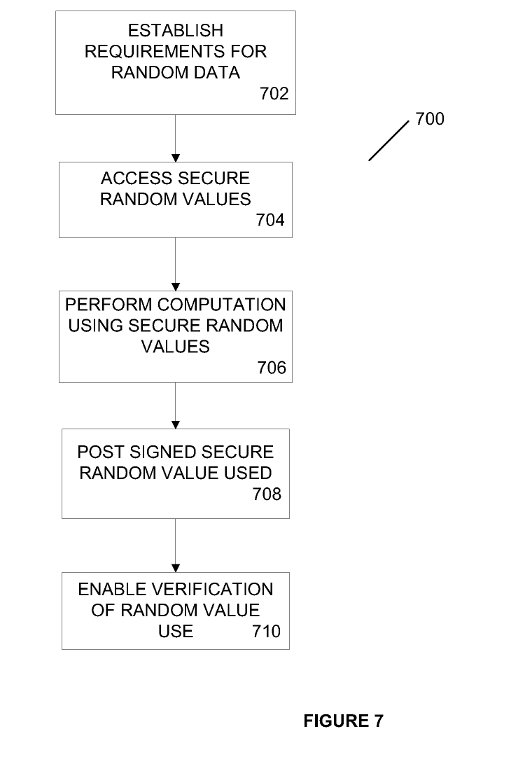

One embodiment reduces opportunities for covert channels by having an independent secure co-processor RANDOM with a physical random number generator which acts as a universal source of randomness. With reference to FIG. 7, in an example process 700, the requirements for random data are determined. The requirements may include generating random number in great excess of what may be required, to account for additional participants to a verifiable secrecy preserving calculation. In one example, upon a request from the EP secure processor, RANDOM sends to the SPEP a list of sequentially numbered and digitally signed random values to be used as help values for the COM operation and as values in Fₚ to be used in the translations. The SPEP access these random values at 704. In some embodiments, the SPEP must use these random strings in the order of their numbering according to a publicly known protocol. In one example, the SPEP uses the random values during the calculation of an output at 706. In another example, whenever a random value from the translations is posted as part of the proof of correctness, the SPEP also posts the signed message from RANDOM as proof of origin at 708. The example process 700 enables the Verifier to check that the posted messages from RANDOM are used in the posted proof in the mandatory order at 710.

The processor is trusted not to output any information beyond that specified by the protocols, and its communications interfaces can be monitored to verify this. The published proof of correctness assures the participants that the output result is really the correct result of the SLC; this means that the validation of the program run by the secure coprocessor need only address information leakage, not program correctness: the program proves itself correct during its normal operation.

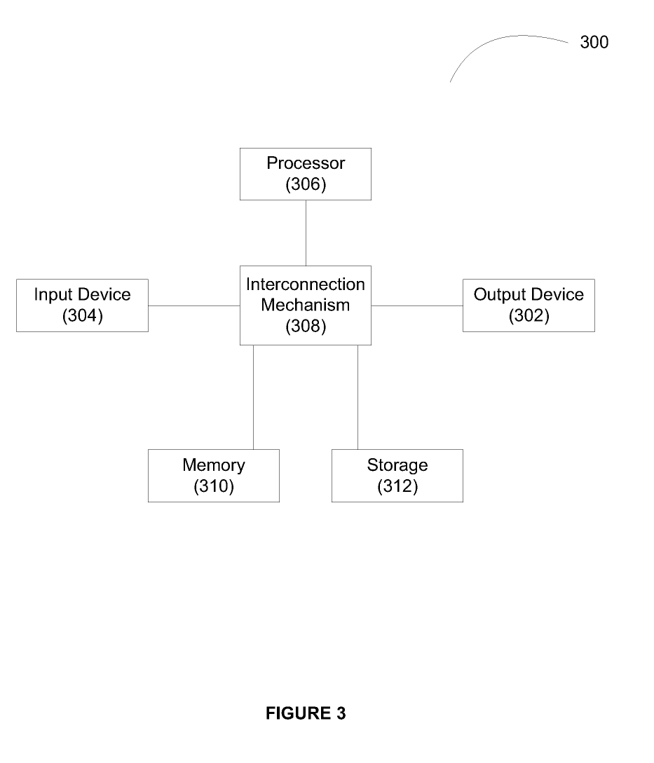

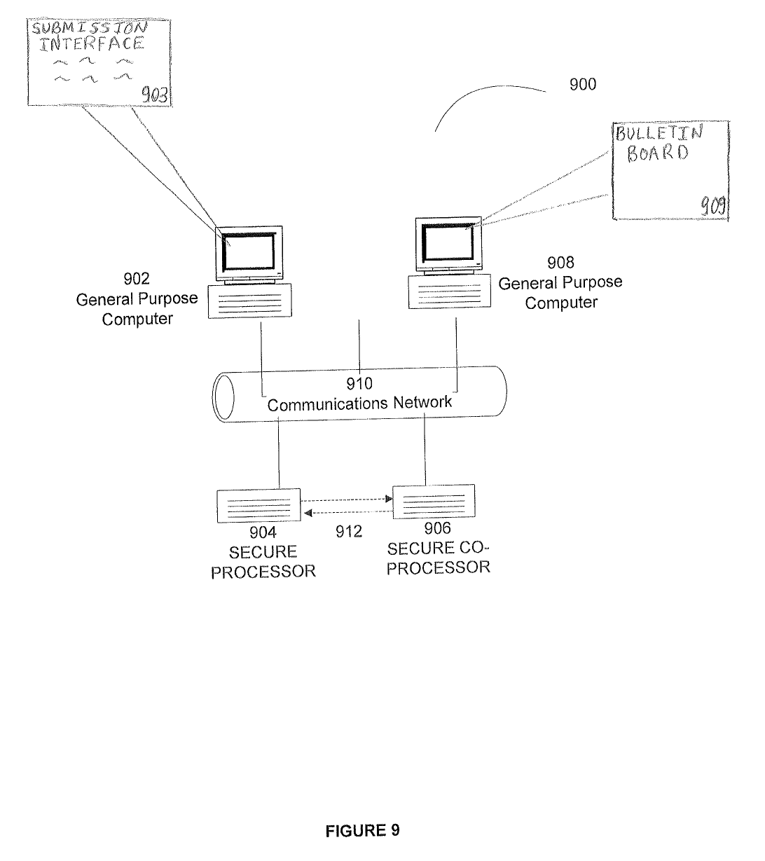

With reference to FIG. 9, system 900, describes an example architecture according a secure processor model. In 900, a secure processor 902, performs the computations discussed above with respect to a secrecy preserving computation. The secure co-processor, 904, generates random data used by the secure processor to perform the computations, commit to computations, etc. The secure processor may by connected directly to the secure co-processor, in one example a dedicated connection is established via 912. In some other embodiments, the direct connection is not required, and communication occurs over a communication network, 910. Using a general purpose computer, 902, a participant/bidder may submit an input for processing using a submission interface, 903. The submission interface may facilitate the generation of commitments, translations, and commitments to the translations, as well as provide for submissions of inputs into the computation. A general purpose computer 908, may also be used to access information posted as part of the computation. In one example, the general purpose computer, 908, is used to access a bulletin board, 909, on which proof information is posted. Various types of information may be posted to the bulletin board. In one example, commitments to inputs, commitments to translations, and proof information are posted. In another example, a winning bidder of a secrecy preserving auction is posted. The bulletin board may be rendered within a web page, using a web browser, and the bulletin board may be a graphical display. General purpose computers, their interfaces, and displays thereon, that may be used are discussed in greater detail herein and with respect to FIGS. 3-5.

An Example of a Practical Implementation of the Evaluator-Prover Method

In one example of a practical implementation of the EP method, which may be used in secure auctions, the form for the computation includes choosing k=40, giving a total probability of error smaller than 3·10⁻¹². The COM (commitment) function for a value in Fₚ, where p has 128 bits, is implemented by randomly choosing a help value rε {0,1}⁴⁰ and setting COM(x)=SHA(r ∥ x)ε {0,1}¹²⁰. In this example, note that COM is randomly many-to-one. This practically precludes feasible searches even if some partial information about x is available.

In one embodiment, the verification of correctness process will not be interactive. According to the embodiment, the proof of correctness of the translations of the SLC (1) will be posted. Namely, the EP prepares the translations TR^{(j)}, 1≦j≦K, and post commitments to all the numbers involved in the translations. Along the lines of the computation of Fiat-Shamir signatures discussed in “How to prove yourself: practical solutions to identification and signature problems,” in Proceedings of CRYPTO'86, pg 186-194, 1987, a hash function H is applied to the concatenation string of all those commitment values.

In one example, the EP extracts from the hash value H(COM(TR⁽¹⁾)∥ . . . ∥ COM(TR^{(K)})) the random challenges used in the verification of the correctness of Aspects 0-8 (discussed above), as required. The EP then de-commits all the values requested in the challenges and posts the values. Using the exposed values, anyone can then verify the correctness of the computation by re-committing the exposed values and by performing additions and multiplications mod p on the exposed values and checking equalities.

In another embodiment, another approach to the creation of the challenges is for the EP first to post the committed-to translations. After the posting, each of the bidders P₁, . . . ,Pₙ sends to the EP an encrypted random string EN(S₁), . . . ,EN(Sₙ). These encryptions are posted by the EP. After that posting the strings S₁, . . . ,Sₙ are revealed and S=S₁ XOR . . . XOR Sₙ defines the random challenges used in the verification. From here on an embodiment of the process proceeds as above. In one embodiment, the known method of Time Lapse Cryptography disclosed in Rabin and Thorpe's “Time-Lapse Cryptography,” Technical Report TR-22-06, Harvard University School of Engineering and Computer Science, 2006, is used to force opening of all the encrypted strings Sᵢ. As discussed in therein, a detailed protocol deals with the possibility that not all bidders Pᵢ submit encrypted strings. In one alternative, P₁, . . . ,Pₙ must submit the encrypted strings EN(S₁), . . . ,EN(Sₙ) together with their bids. In another alternative embodiment, the revelation of the strings is then timed by the protocol to occur after the posting of the committed-to translations by the EP.

As discussed above, various embodiments according to the present invention may be implemented on one or more computer systems. These computer systems may be, for example, general-purpose computers such as those based on Intel PENTIUM-type processor, Motorola PowerPC, AMD Athlon or Turion, Sun UltraSPARC, Hewlett-Packard PA-RISC processors, or any other type of processor. It should be appreciated that one or more of any type computer system may be used to facilitate the verifiable determination of an output based on submitted inputs according to a predetermined calculation that preserves secrecy of underlying information according to various embodiments of the invention. Further, the system may be located on a single computer or may be distributed among a plurality of computers attached by a communications network.

A general-purpose computer system according to one embodiment of the invention is configured to perform any of the described functions, including but not limited to calculating an output, translating a value, generating a randomized representation of a value, generating commitments, publishing commitments, digitally signing inputs, digitally signing commitments, digitally signing translations, revealing portion(s) of randomized representations, and permitting verification of the calculating of the output. It should be appreciated, however, that the system in some embodiments, performs other functions, including performing financial transactions related to the computations, i.e. in an auction setting for example, receiving payments from customers, providing indications to bidders regarding the status of the auction, etc., and the invention is not limited to having any particular function or set of functions. Additional functions in some embodiments also include, performing addition, subtraction, multiplication, inequality, equality, and exponentiation operations, performing operations on randomized representations of values, representing the operations on randomized representations of values as further randomized representations, generating commitments to each component of the computation, generating commitments that are binding, generating commitments that are concealing, generating commitments that are binding and concealing, as well as receiving inputs from participants, generating by participants translations of inputs and commitments to the inputs and translations. Additionally some embodiment also perform functions related to verification of the computation, wherein the functions permit secrecy preserving verification as discussed above. A general-purpose computer system according to one embodiment of the invention is also configured to perform the functions of secure computation of random values, the generation of commitments for the random values, and digitally signing the commitments to the random values, among other functions, for example hosting a bulletin board for a computation, and rendering a submission interface. Such general purpose computers may also be configured to operate in a secure manner, and may be used to provide secure processing of the above functions, and provide for secure generation of random values.

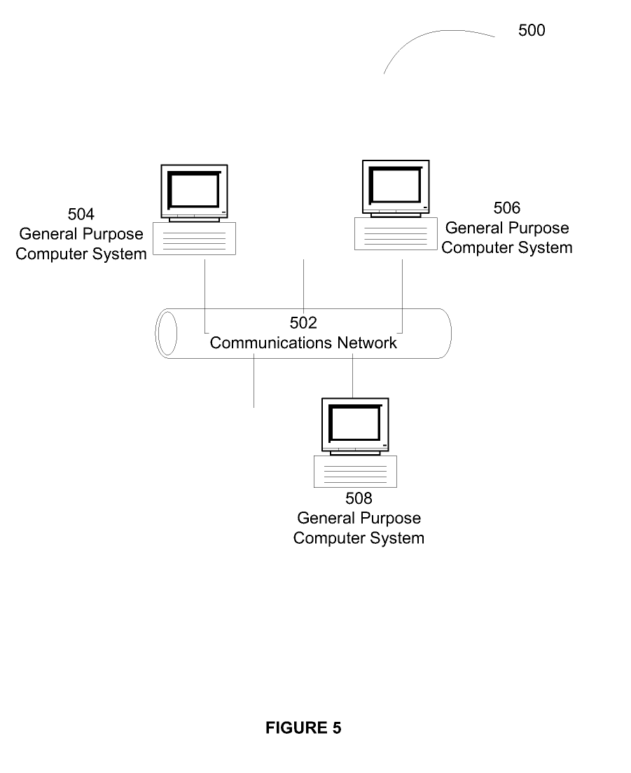

FIG. 3 shows a block diagram of a general purpose computer system 300 in which various aspects of the present invention may be practiced. For example, various aspects of the invention may be implemented as specialized software executing in one or more computer systems including general-purpose computer systems 504, 506, and 508 communicating over network 502 shown in FIG. 5. Computer system 300 may include a processor 306 connected to one or more memory devices 310, such as a disk drive, memory, or other device for storing data. Memory 310 is typically used for storing programs and data during operation of the computer system 300. Components of computer system 300 may be coupled by an interconnection mechanism 308, which may include one or more busses (e.g., between components that are integrated within a same machine) and/or a network (e.g., between components that reside on separate discrete machines). The interconnection mechanism enables communications (e.g., data, instructions) to be exchanged between system components of system 300.

Computer system 300 may also include one or more input/output (I/O) devices 304, for example, a keyboard, mouse, trackball, microphone, touch screen, a printing device, display screen, speaker, etc. Storage 312, typically includes a computer readable and writeable nonvolatile recording medium in which signals are stored that define a program to be executed by the processor or information stored on or in the medium to be processed by the program.

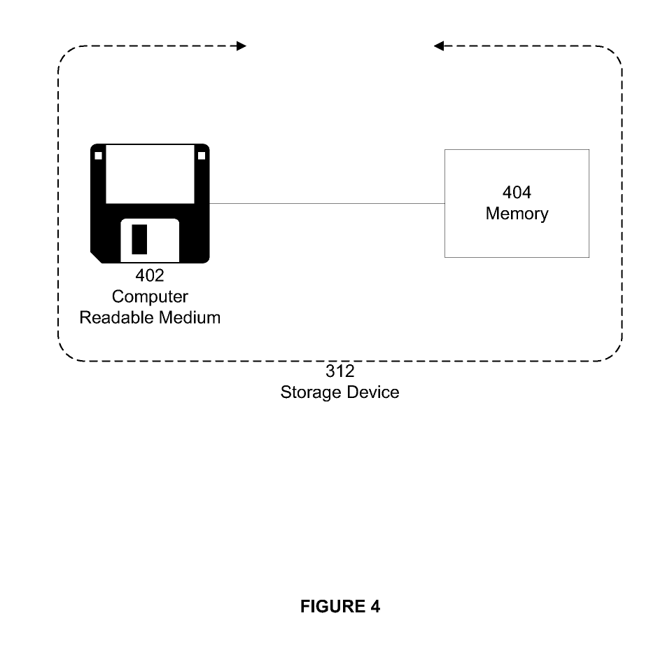

The medium may, for example, be a disk 402 or flash memory as shown in FIG. 4. Typically, in operation, the processor causes data to be read from the nonvolatile recording medium into another memory 404 that allows for faster access to the information by the processor than does the medium. This memory is typically a volatile, random access memory such as a dynamic random access memory (DRAM) or static memory (SRAM).

Referring again to FIG. 3, the memory may be located in storage 312 as shown, or in memory system 310. The processor 306 generally manipulates the data within the memory 310, and then copies the data to the medium associated with storage 312 after processing is completed. A variety of mechanisms are known for managing data movement between the medium and integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 300 is shown by way of example as one type of computer system upon which various aspects of the invention may be practiced, it should be appreciated that aspects of the invention are not limited to being implemented on the computer system as shown in FIG. 3. Various aspects of the invention may be practiced on one or more computers having a different architectures or components that that shown in FIG. 3.

Computer system 300 may be a general-purpose computer system that is programmable using a high-level computer programming language. Computer system 300 may be also implemented using specially programmed, special purpose hardware. In computer system 300, processor 306 is typically a commercially available processor such as the well-known Pentium class processor available from the Intel Corporation. Many other processors are available, including multi-core processors. Such a processor usually executes an operating system which may be, for example, the Windows-based operating systems (e.g., Windows Vista, Windows NT, Windows 2000 (Windows ME), Windows XP operating systems) available from the Microsoft Corporation, MAC OS System X operating system available from Apple Computer, one or more of the Linux-based operating system distributions (e.g., the Enterprise Linux operating system available from Red Hat Inc.), the Solaris operating system available from Sun Microsystems, or UNIX operating systems available from various sources. Many other operating systems may be used, and the invention is not limited to any particular operating system.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems (e.g., servers) configured to provide a service to one or more client computers, or to perform an overall task as part of a distributed system. For example, various aspects of the invention may be performed on a client-server or multi-tier system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Various aspects of this system can be implemented by one or more systems similar to system 300. For instance, the system may be a distributed system (e.g., client server, multi-tier system) comprising multiple general-purpose computer systems. In one example, the system includes software processes executing on a system associated with a participant in the computation (e.g., a client computer system). These systems in some embodiments permit the participant to access the computation, submit inputs, generates a commitment to the input, generate translations to the input, commitments to the translations, among other functions. There may be other computer systems, such as those installed at an operator's location that perform functions such as receiving inputs from participants, receiving commitments to the input, receiving translations and commitments to translations, verifying the received information, performing a computation on the received information, generating translations used in the computation, revealing information for verifying the computation, receiving secure random values for use in the computation, and providing information for verifying proper use of the secure random values, among other functions. As discussed, these systems according to some embodiments, are distributed among a communication system such as the Internet. One such distributed network, as discussed below with respect to FIG. 5, may be used to implement various aspects of the present invention.

FIG. 5 shows an architecture diagram of an example distributed system 500 suitable for implementing various aspects of the present invention. It should be appreciated that FIG. 5 is used for illustration purposes only, and that other architectures may be used to facilitate one or more aspects of the present invention.

System 500 may include one or more general-purpose computer systems distributed among a network 502 such as, for example, the internet. Such systems may cooperate to perform functions related to the verifiably correct auction. In an example of one such system for conducting a verifiably correct auction, one or more participants operate one or more client computer systems 504, 506, and 508 through which inputs and commitments are submitted for use in a verifiably correct computation. In one example, participants interface with the system via an internet-based interface.

In another example, a system 504 includes a browser program such as the Microsoft Internet Explorer application program through which one or more websites may be accessed. Further, there may be one or more application programs that are executed on system 504 that perform functions associated with the verifiably correct computation. Some embodiments of system 504 include one or more local databases including, but not limited to, information relating to a current computation that is underway.

Other embodiments of network 502 also include, as part of the system for conducting a verifiably correct computation one or more server systems, which may be implemented on general purpose computers that cooperate to perform various functions of the system for conducting a verifiably correct computation including verification of submissions, translation of values, accessing secure random values, performing operations on randomized representations of values, representing results of operations as further randomized representations, generating randomized representations of zero, revealing at least a portion of randomizes representations to permit verification of the computation, and other functions (for example the functions discussed above). System 500 may execute any number of software programs or processes and the invention is not limited to any particular type or number of processes. Such processes may perform the various workflows associated with the system for conducting a verifiably correct auction.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer implemented method for verifiably determining at least one output resulting from at least one submitted input according to a predetermined calculation while preserving secrecy of the at least one submitted input and of intermediate values arising in the calculation, the method comprising;
calculating at least one output resulting from at least one input submitted by at least one participant according to a predetermined calculation;
translating a value in the calculation into a randomized representation of that value, wherein the randomized representation comprises at least two components and the at least two components determine the said value through a function;
publishing commitments to the at least two components of the randomized representation of that value;
revealing a portion of the randomized representation in response to a verification request; and
enabling verification of the calculation of the outputs using the revealed portion of the randomized representation.

2. The method according to claim 1, further comprising an act of augmenting the predetermined calculation by insertion of auxiliary values.

3. The method according to claim 1, wherein the predetermined calculation includes at least one operation of addition, subtraction, multiplication, establishing an inequality between values, and exponentiation.

4. The method according to claim 1, wherein the act of enabling verification of the calculation includes using published commitments.

5. The method according to claim 1, further comprising an act of submitting, by a participant, an input, and a commitment to the input, and wherein the act of translating the value includes an act of translating, by the participant, the input into a randomized representation of the input, wherein the randomized representation of the input comprises at least two components and the at least two components determine the input through a function.

6. The method according to claim 1, wherein the at least two components are a pair of components.

7. The method according to claim 6, wherein the pair of components determine the value through at least one of the functions of addition, subtraction, multiplication.

8. The method according to claim 7, where the randomized representation of the value in the calculation comprises a sum of the at least two components of the randomized representation.

9. The method according to claim 8, where the sum of values is represented by at least two components each of which is the sum of corresponding components of representations of the values added to yield the sum.

10. The method according to claim 6, wherein the act of revealing a portion of the randomized representation includes revealing one component of the pair of components.

11. The method according to claim 2, further comprising an act of translating a value in the augmented calculation into a plurality of randomized representations of the value.

12. The method according to claim 11, further comprising acts of:
generating a randomized representation of zero, wherein the randomized representation of zero comprises at least two components, wherein the at least two components recover the original value upon application of a function, and wherein the act of translating a value in the calculation into a randomized representation of the original value includes an act of employing the randomized representation of zero in generating randomized representations of calculation values.

13. The method according to claim 12, further comprising an act of revealing the at least two components of the randomized representation of zero in response to a request for verification.

14. The method according to claim 13, further comprising an act of permitting the verification of the randomized representation of zero.

15. The method according to claim 1, wherein the act of calculating the output based on received inputs, includes an act of performing multiple calculations as single operations to reduce the randomized representations required.

16. The method according to claim 1, wherein the act of enabling the verification of the calculation further comprises an act of enabling verification of at least one of a consistent representations of the input, a correct representation of zero, a correct representation of an addition with zero, a correct representation of an addition operation in the predetermined calculation, a correct representation of a multiplication operation in the predetermined calculation, a correct representation of an exponentiation operation in the predetermined calculation.

17. The method according to claim 1, wherein the method is performed by a secure processor connected to an independent secure co-processor that generates random values incorporated into at least one random representation of the value in the predetermined calculation.

18. The method according to claim 1, wherein the act of calculating is performed by a calculating entity and the method further comprises an act of publishing a commitment to at least one random value before the at least one input is known to the calculating entity.

19. The method according to claim 18, further comprises an act of generating the commitments to the at least two components using the at least one random value, and wherein the act of enabling verification of the calculation includes verification of proper use of the at least one random value.

20. A system for generating a verifiable output according to a predetermined calculation on at least one submitted input that provides for secrecy of the at least one submitted input and of intermediate values in the calculation, the system comprising:
a calculation component adapted to calculate at least one output from at least one input received from a participant, according to a predetermined calculation;
a translation component adapted to translate a value in the predetermined calculation into a randomized representation of the value, wherein the randomized representation comprises at least two components and the at least two components determine the value through a function; and
a publication component adapted to publish commitments to the at least two components, wherein the publication component is further adapted to reveal a portion of the randomized representation of the value.

21. The system according to claim 20, further comprising a verification component adapted to verify the calculation of the at least one output using at least one of the revealed portion of the randomized representation of the value and the commitments to the at least two components.

22. The system according to claim 20, wherein the calculation component is further adapted to perform at least one operation of addition, subtraction, multiplication, establishing an inequality between values, and exponentiation.

23. The system according to claim 22, wherein the calculation component is further adapted to perform the at least one operation on the randomized representation of the value.

24. The system according to claim 20, further comprising a receiving component adapted to receive an input, and a commitment to the input from a participant.

25. The system according to claim 20, wherein the translation component is further adapted to translate the at least one input into a randomized representation of the input, wherein the randomized representation of the input comprises at least two components and the at least two components determine the input through a function.

26. The system according to claim 20, wherein the at least two components are a pair of components.

27. The system according to claim 26, wherein the pair of components determine the value through at least one of the functions of addition, subtraction, and multiplication.

28. The system according to claim 20, wherein the randomized representation of the value in the calculation comprises a sum of the at least two components of the randomized representation.

29. The system according to claim 28, wherein the sum of values is represented by at least two components each of which is the sum of corresponding components of representations of the values added to yield the sum.

30. The system according to claim 26, wherein the publication component is further adapted to reveal one component of the pair of components.

31. The system according to claim 20, wherein the translation component is further adapted to translate a value in the calculation into a plurality of randomized representations of the value.

32. The system according to claim 20, wherein the translation component is further adapted to generate random representations of zero; and
translate the value in the in the predetermined calculation using the random representation of zero, wherein the random representation of zero comprises at least two components, wherein the at least two components determine zero through a function.

33. The system according to claim 32, wherein the publication component is further adapted to reveal the at least two components of the randomized representation of zero.

34. The system according to claim 33, further comprising a verification component adapted to verify the randomized representation of zero using the revealed at least two components.

35. The system according to claim 21, wherein the verification component is further adapted to verify at least one of a consistent representations of the input, a correct representation of zero, a correct representation of an addition with zero, a correct representation of an addition operation in the predetermined calculation, a correct representation of a multiplication operation in the predetermined calculation, a correct representation of an exponentiation operation in the predetermined calculation, and a correct representation of establishing an inequality between values.

36. The system according to claim 20, further comprising a secure processor adapted to generate random data, and wherein the translation component is further adapted to employ the random data to translate a value in the in the predetermined calculation into a randomized representation of the value.

37. The system according to claim 20, further comprising a security component adapted to publish a commitment to at least one random value before the at least one input is processed by the calculation component.

38. The system according to claim 37, further comprising a generation component adapted to generate the commitments to the at least two components using the at least one random value.

39. A computer-readable medium having computer-readable signals stored thereon that define instructions that, as a result of being executed by a computer, instruct the computer to perform a method for verifiably determining an output while preserving secrecy of inputs and calculations thereon, the method comprising:
calculating at least one output according to a predetermined calculation from at least one input submitted by at least one participant;
translating a value in the predetermined calculation into a randomized representation of the value, wherein the randomized representation comprises at least two components and the at least two components determine the value through a function;
publishing commitments to the at least two components of the randomized representation;
revealing a portion of the randomized representation in response to a verification request; and
enabling verification of the calculation of the at least one output using the revealed portion of the randomized representation.

40. A method for verifiably determining a winning bidder while preserving secrecy of other bids, the method comprising;
calculating, according to announced rules, a winning bidder based on received bids from participants;
translating a value in the calculation into a randomized representation of that value, wherein the randomized representation comprises at least two components and the at least two components determine the value through a function;
publishing commitments to the at least two components of the randomized representation;
revealing a portion of the randomized representation in response to a verification request; and
enabling verification of the calculation of the winning bidder using the revealed portion of the randomized representation.

41. The method according to claim 40, wherein the calculation includes at least one operation of addition, subtraction, multiplication, and establishing an inequality between values.

42. The method according to claim 40, wherein the act of enabling verification of the winning bidder includes using the published commitments.

43. The method according to claim 40, further comprising an act of submitting, by a bidder, a bid, and a bid commitment, and wherein the act of translating the bid value includes an act of translating, by the bidder, the bid into a randomized representation of the bid, wherein the randomized representation of the bid comprises at least two components and the at least two components determine the bid through a function.

44. The method according to claim 40, wherein the at least two components are a pair of components.

45. The method according to claim 44, wherein the pair of components determine the value through at least one of the operations of addition, subtraction, and multiplication on the pair of components.

46. The method according to claim 44, wherein the act of revealing a portion of the randomized representation includes revealing one component of the pair of components.

47. The method according to claim 40, further comprising an act of transforming a value in the calculation into a plurality of randomized representations of the original value.

48. The method according to claim 47, further comprising acts of:
generating a randomized representation of zero, wherein the randomized representation of zero comprises at least two components, wherein the at least two components recover the original value upon application of a function; and wherein the act of translating a value in the calculation into a randomized representation of the original value includes an act of employing the randomized representation of zero in generating randomized representations of calculation values.

49. The method according to claim 48, further comprising an act of revealing the at least two components of the randomized representation of zero in response to a request for verification.

50. The method according to claim 49, further comprising an act of enabling the verification of the randomized representation of zero.

51. The method according to claim 40, wherein the act of calculating a winning bidder based on received bids from participants, includes performing multiple calculations as single operations to reduce the randomized representations required.
